(19) United States
(12) Patent Application Publication
(10) Pub. No.: US 2024/0131944 A1
(43) Pub. Date: Apr. 25, 2024

(54) Overhead Automated Electric Vehicle Charging System

(71) Applicant: Michael J. Lamore, Greensboro, NC (US)

(72) Inventor: Michael J. Lamore, Greensboro, NC (US)

(21) Appl. No.: 18/494,688

(22) Filed: Oct. 24, 2023

Related U.S. Application Data
(60) Provisional application No. 63/380,833, filed on Oct. 25, 2022.

(51) Int. Cl. B60L 53/35; B60L 53/18

(52) U.S. Cl. CPC B60L 53/35; B60L 53/18

(57) ABSTRACT

A system for charging an electric vehicle from an overhead position includes a storage container defining an interior space therein and a bottom lid connected to the storage container. A charging cable fits within the interior space of the storage container. A charging controller connects the charging cable to a power source and has wireless communications hardware to receive wireless data that operates the system. An automated actuator is in data communication with electronic hardware to move the charging cable out of the storage container. A lid cable and/or a retractor cable is connected to the automated actuator to control the position of the bottom lid and/or the charging cable.

### CROSS REFERENCE TO RELATED APPLICATIONS

This application claims priority to and incorporates entirely by reference U.S. Provisional Patent Application Ser. No. 63/380,833 filed on Oct. 25, 2022, and entitled Overhead Automated Electric Vehicle Charging System.

### FIELD OF DISCLOSURE

The current invention relates to electric vehicle (EV) charging and, more particularly, overhead positioned electrical vehicle (EV) charging systems with automation and controls to charge vehicles conveniently and efficiently. With this invention, the charging gun 4 has greater accessibility to multiple charging port locations within the charging station, and is delivered and retracted from overhead positions using automated and wireless controls so that the charging cable 3, 5 avoids interferences, floor obstacles, dragging across concrete, and tripping hazards. Electrical vehicles in this disclosure refers to cars, trucks, vans, motorcycles, carts, lawnmowers, and any other devices that transport people, goods, or products.

### BRIEF SUMMARY OF THE DISCLOSURE

In one embodiment of this disclosure, a system for charging an electric vehicle includes a storage container 16 defining an interior space 16a between a first surface 19a opposite a bottom lid 17 and side walls 36 connecting the first surface 19a and the bottom lid 17. Without limiting this disclosure, the first surface may be a surface of one of the side walls, a top lid of the storage container, or even a mounting surface such as a ceiling 12 that encloses the storage container. At least one attachment mechanism 15 is connected to the storage container 16 and configured to mount the storage container 16 in an elevated position relative to a ground surface. The ground surface 21 may be any surface, including but not limited to a garage floor, a parking lot, a parking place, or outside ground areas, so long as the ground surface is sufficient for an electric vehicle to park under or at least near the storage container 16. The system further includes a charging cable 3, 5 secured at least partially within the interior space 16a of the storage container 16. In some embodiments, the charging cable 3, 5 is configured to mate with or connect to a charging port on an electric vehicle. In some non-limiting embodiments, a bottom lid 17 may be connected to the storage container 16 by a hinge 18, wherein the lid is selectively opened for user access to the charging cable.

In another embodiment, a system for charging an electric vehicle may include a storage container 16 defining an interior space 16a therein and generally positioned above a ground surface on which a vehicle can park. A charging cable 3, 5 is at least partially within the interior space 16a of the storage container. The bottom lid 17 may optionally be connected to the storage container 16 by a hinge 18, wherein the bottom lid 17 is selectively opened for user access to the charging cable 3, 5. In this embodiment, a charging cable retractor assembly 146 may be positioned within the storage container 16 and connected to the charging cable 3, 5, wherein the charging cable retractor assembly selectively allows the charging cable 3, 5 to extend away from the bottom lid 17 for charging and retract into the storage container 16 for storage. Similar to embodiments already described, a retractor line 148 is extendable and retractable from the charging cable 3, 5 retractor assembly and connected to the charging cable. The retractor line 148 may be moved to an extended position to move the charging cable 3, 5 to a suspended position when the bottom lid opens, and the retractor line 148 may be moved to a retracted position that holds the charging cable 3, 5 proximately to the bottom lid in a closed position.

In another embodiment of this disclosure a charging cable storage apparatus may utilize a fixed bottom lid 17, such as a bottom wall 17a, secured to the other side walls 36, and the storage container 16 in those embodiments defines a payout aperture 121 through which the charging cable 3, 5 extends for use. The payout aperture 121 may allow access to an interior space 16a of the storage container 16 through a side wall 36 or even the bottom wall 17a. In this non-limiting implementation, a system for charging an electric vehicle or any other battery operated machine may include a storage container 16 defining an interior space 16a between a bottom lid 17a and side walls 36 connecting a first surface and the bottom lid 17. At least one attachment mechanism 15 may be connected to the storage container 16 and configured to mount the container in an elevated position relative to a ground surface. A charging cable 3, 5 is secured at least partially within the interior space 16a of the storage container. An actuator 33 may be positioned at least partially within the interior space 16a of the storage container 16 and configured to advance the charging cable 3, 5 generally in a direction across a long axis 16a of the storage container 16 (i.e., from end to end of the storage container), which correspondingly moves an end of the charging cable 3, 5 outside the storage container 16 in a direction toward the ground surface 21.

### BRIEF DESCRIPTION OF THE DRAWINGS

The drawings are provided as examples. The present invention may be embodied in many different forms and should not be construed as limited to the examples depicted in the drawings.

FIG. 1 is a top view of the charging components comprising a power cable, charging controller 2, spiral charging cable 3, 5 that extends and retracts, and charging gun 4 in accordance with an embodiment of this disclosure.

FIG. 2 is another view of the charging components of FIG. 1, except for schematically depicting a straight power charging cable 3, 5 in a wrapped configuration.

FIG. 3 is another view of the charging components of FIG. 1, except for schematically depicting a combined spiral charging cable 3, 5 and straight charging cable 3, 5 connected in series.

FIG. 4. is a side view of charging station with vehicle parked and the overhead automated EV charging system in the up position and mounted to the ceiling 12.

FIG. 5 is another view of the charging station of FIG. 4, except for schematically depicting the overhead automated EV charging system in the down position and charging gun 4 plugged into vehicle charging port located at rear of vehicle.

FIG. 6 is top view of wireless controller with key chain connector.

FIG. 7 is another view of the charging station of FIG. 5, except for further schematically depicting a spiral charging cable 3, 5 in the extended position and charging gun 4 plugged into the vehicle's charging port located at front of vehicle.

FIG. 8. is a front view of a dual EV charging system in the down position and comprising two (2) charging controller 2s, spiral charging cables, and charging gun 4s that are plugged into the vehicle's charging port on each side for simultaneously charging.

FIG. 9 is a top view of the overhead automated EV charging system in the up position and illustrating the system components stored inside in their assembled configuration.

FIG. 10 is a right-side view of the overhead automated EV charging system of FIG. 9 schematically depicting components that illustrate the overhead automated EV charging system attached to the ceiling 12 in the up position, and the linear actuator 33 rod in the extended position.

FIG. 11 is another view of the overhead automated EV charging system of FIG. 10, except for schematically depicting components that illustrate the overhead automated EV charging system in the down position with the spiral power charging cable 3, 5 in the stored position, and the linear actuator 33 rod in the retracted position.

FIG. 12 is another view of the overhead automated EV charging system of FIG. 9, schematically depicting components that illustrate the overhead automated EV charging system in the down position, and an extended spiral charging cable 3, 5 comprising an inner elastic cord 66 that subsidizes extension and retraction of the charging cable.

FIG. 13 is another view of the overhead automated EV charging system of FIG. 10, except for schematically depicting the overhead automated EV charging system with vertical telescoping connection brackets that allow for system height adjustments.

FIG. 14 is another view of the overhead automated EV charging system of FIG. 11, except for schematically depicting a long, straight charging cable 3, 5 wrapped and in the stored position.

FIG. 15 is another view of the overhead automated EV charging system of FIG. 11, except for schematically depicting a straight power charging cable 3, 5 in multiple extended positions to illustrate unrestricted vertical and horizontal positioning of charging gun 4 to connect to a vehicle's charging port.

FIG. 16 is another view of the overhead automated EV charging system of FIG. 11, except for further schematically depicting a straight and spiral charging cable 3, 5 connect in series and in multiple extended positions to illustrate unrestricted vertical and horizontal positioning of charging gun 4 to connect to a vehicle's charging port.

FIG. 17 is another view of the overhead automated EV charging system of FIG. 12, except for schematically depicting a tilt-swivel telescoping bar to position the charging cable 3, 5 and gun both vertically and horizontally, when the overhead automated EV charging system is in the down position.

FIG. 18 is a top view of the linear actuator 33 rod end schematically depicting the components in their assembled configuration where the cable rotates around a grooved wheel with a cable stay as the actuator 33 rod is extended or retracted to raise or lower the lid.

FIG. 19 is another view of the linear actuator 33 rod end of FIG. 18 schematically depicting the cable above the wheel that has a fixed connection and the cable below the wheel that is connected to the pivoting bottom lid 17, whereas the bottom lid moves 2 foot for every 1 foot that the actuator 33 rod moves providing a 2:1 mechanical advantage.

FIG. 20 is a top view of the lower lid cable wheel and support bar located below the linear actuator 33 and schematically depicting the components in their assembled configuration where the cable below the actuator 33 is routed around the wheel to optimize the cable's deflection prior to connected to the pivoting lid cable.

FIG. 21 is a top view of charging gun 4 in holster 38 fastened to the pivoting bottom lid and schematically depicting the vertical stay pins that bend forward at the top and hold the charging gun 4 in its stored position, and a limit switch that prevents the bottom lid from being raised when the charging gun 4 is in the removed position.

FIG. 22 is a front view of the charging gun 4 of FIG. 21 with the charging gun 4 in the removed position schematically depicting the charging gun 4 stay pins sliding closer together with the compression springs extended, and the limit switch spring lever rotating up to send signal across wire that disengages the lid raising function.

FIG. 23 is a front view of the charging gun 4 of FIG. 21, with charging gun 4 positioned in the holster 38 that further schematically depicts the charging gun 4 stay pins sliding apart and pressed against the charging gun 4 with the springs in the compressed positions, and the limit switch spring lever in the down position allowing operation of the lid raising function.

FIG. 24 is another embodiment of FIG. 23 schematically depicting a proximity switch fastened to the charging gun 4 stay pins and proximity switch trigger around the charging gun 4 handle, to disengage raising of the pivoting bottom lid when the charging gun 4 is positioned out of the holster 38.

FIG. 25 is another embodiment of an overhead automated EV charging system, except schematically depicting a dual overhead automated EV charging system comprising two (2) charging controller 2s, spiral charging cables, and charging gun 4s.

FIG. 26 is another embodiment of this disclosure illustrating the overhead automated EV charging system that is manually movable in a linear direction and schematically depicting the trolley wheels with brake disengaged and connected to the horizontal track fastened to the ceiling 12, and a rotating pull-push bar to manually move the system.

FIG. 27 is another embodiment of this disclosure schematically depicting a lid that is in the down position and a rotating bar that is first in the pull-push position where brake is disengaged, and second in the resting position where the brake activation chord is pulled down and automatically engages the brake against the beam on the other side.

FIG. 28 is top view of the power cable delivery as the overhead automated EV charging system moves in a linear direction, and schematically depicting a support casing rotating around a fixed ceiling 12 connection with the power cable remaining connected as the system moves in a linear direction.

FIG. 29 is another view of the embodiments of this disclosure, except schematically depicting overhead automated EV charging system moved by a linear motion system where, in this embodiment, a motor turns a threaded rod which extends through a ball screw connected to the system.

FIG. 30 is a top view of another embodiment of overhead EV automated charging system with fixed bottom lid and schematically depicting a linear actuator 33 rod in the retracted position with a horizontal wheel connected at rod end where the straight charging cable 3, 5 is routed around, and the charging cable 3, 5 is raised and lowered from an exterior cable drop wheel as the actuator 33 rod is retracted and extended, where the constant tensioning device 153 and retraction line pull the charging cable 3, 5 when the actuator 33 rod is extended for exterior cable drop

FIG. 31 depicts the overhead automated EV charging system, except schematically depicting the actuator 33 rod extended and the constant tensioning device 153 line is retracted, and the charging cable 3, 5 is lowered from the exterior wheel a distance of about 2× the length that the actuator 33 rod is extended, while the charging cable 3, 5 remains fixed on the other side.

FIG. 32 is right side view of the overhead automated EV charging system of FIG. 31 schematically depicting the charging cable 3, 5 routed around the exterior cable drop wheel, an adjustable counterweight fastened below the charging gun 4 to provide a force that pulls down the power cable as the actuator 33 rod is extended.

FIG. 33 is a top view of a charging cable 3, 5 schematically depicting a flexible exterior wire group added to the outside of the charging cable 3, 5 and a protective exterior wrap.

FIG. 34 is a top view of charging gun 4 schematically depicting the charging gun 4's standard connection lever and lip with activation wire, and a compression spring system as the automated ejection mechanism of the charging gun 4 from the vehicle port.

FIG. 35 is another view of a charging gun 4 plugged into the vehicle's charging port and further schematically depicting the springs in the compressed position and the charging gun 4's connection lip attached to the standard charging port's ridge.

FIG. 36 is another view of a charging gun 4, further schematically depicting the automated release of the charging gun 4 from vehicle charging port where the activation wire releases the charging gun 4's lip connection to the vehicle charging port, and the compression springs extend resulting in ejection of the charging gun 4 from the charging.

FIG. 37 is another view of the charging gun 4, except illustrating another embodiment that schematically depicts an active plunger as the mechanism to eject the charging gun 4 from vehicle charging port, where an activation wire releases the charging gun 4's lip connection, and another activation wire simultaneously active the plungers.

FIG. 38 is another view of the charging gun 4 with charging gun 4 plugged into the vehicle's charging port and further schematically depicting the active plunger in the retracted or loaded position, and the charging gun 4's connection lip attached to the standard charging port's ridge.

FIG. 39 is another view of the charging gun 4, further schematically depicting the automated release of the charging gun 4 from vehicle charging port where the activation wire releases the charging gun 4's lip connection to the vehicle charging port, and the other wire activates the plunger extension resulting in ejection of the charging gun 4 from the charging port.

FIG. 40 is another embodiment of the storage container 16 and bottom lid of this disclosure, except illustrating another embodiment that schematically depicts an electro-magnet as the mechanism to eject the charging gun 4 from vehicle charging port, where an activation wire releases the charging gun 4's lip connection, and another activation wire simultaneously activates the electro-magnet connection to repel.

FIG. 41 is another view of the embodiments of this disclosure with a charging gun 4 plugged into the vehicle's charging port and further schematically depicting the electro-magnet with polarity that attracts and connects it to the charging port's magnetic plate, and the charging gun 4's connection lip attached to the standard charging port's ridge.

FIG. 42 is another view of the charging gun 4 of FIG. 41, further schematically depicting the automated release of the charging gun 4 from vehicle charging port where the activation wire releases the charging gun 4's lip connection to the vehicle charging port, and the other wire reverses polarity of the electro-magnet and repels it against the charging port's magnetic plate, resulting in ejection of the charging gun 4 from the charging port.

FIG. 43 is a top view of another embodiment of the overhead automated EV charging system with the lid in the closed position schematically depicting a self-locking retractor device for extension of the charging cable 3, 5 with self-locking without tension and retraction of the charging able to within the container, a rotating lever arm 161 that pivots to optimize the position of the charging cable 3, 5 during charging, and the charging controller 2 in a fixed position facing downward.

FIG. 44 is a right-side view of the overhead automated EV charging system of FIG. 43 schematically depicting components to include the self-locking retractor device wire redirected around the wheel and connecting the charging cable 3, 5, the rotating lever arm 161 and constant tensioning device 153 and line redirected around the wheel, the fixed charging controller 2, and the charging gun 4.

FIG. 45 is another view of the overhead automated EV charging system of this disclosure, except for schematically depicting the lid in the lowered position where a section of the charging cable 3, 5 and charging gun 4 remain attached to the lid.

FIG. 46 is another view of an overhead automated EV charging system, except for schematically depicting the charging gun 4 removed and positioned for EV charging at the front, the retractor device wire extended and self-locked to remove tension on its wire, and the arm is rotated to optimize the position of the charging cable 3, 5 for frontal charging with the constant tension line extended.

FIG. 47 is another view of an overhead automated EV charging system, except for schematically depicting the charging gun 4 positioned for rear EV charging and the arm further rotated and the constant tension line further extended to optimize the position of the charging cable 3, 5 for rear charging.

FIG. 48 is a front view of the lid in the down position that schematically depicts the charging gun 4 in the holster 38, the guard rails on each side of the lid that contain the charging cable 3, 5 and controls wire, the protective coating at the end of the lid, and the support handle to hold the lid still when the charging gun 4 is removed or fastened to the holster 38.

FIG. 49 is another view of the lid of FIG. 49, except for schematically depicting the charging gun 4 removed from the holster 38 and further depicting the fastening device for the charging gun 4 to the holster 38, controls switch that disables the bottom lid raising function when the charging gun 4 is removed, and the bumper sensor located below the bottom lid that changes its motion if encountering an obstruction while moving.

### DETAILED DESCRIPTION

In one embodiment of this disclosure, an electric vehicle (EV) charging system 14 is embodied in a charging system storage container 16 that is configured to attach to a ceiling 12 of a charging station 6. The charging system storage container 16 is defined by a plurality of container walls 19 making up the system exterior panel frame. In non-limiting embodiments, the charging system storage container 16 may have a pivoting bottom lid 17 connected to the storage container 16 by a hinge 18, and the pivoting bottom lid 17 is further connected to mechanical components arranged to allow for opening and closing the pivoting bottom lid 18 under the control of an electronic hardware configuration (e.g., 53, 86, 89, 166, 171) or a computer, an actuator 33, a motor and the like. In one embodiment, a linear actuator assembly 33 is connected to a power source 7 and has a drive unit or actuator motor 52 to move the linear actuator 33 to and from a lid cable 23 that is connected to the bottom lid 17. Movement of the linear actuator 33 is under the direction of operational data in communication with the drive system of the linear actuator 33. In non-limiting embodiments, tension on the lid cable 23 is increased to close the pivoting bottom lid 17 and decreased to allow the bottom lid 17 to fall open while still connected to the lid cable 23. Control of the lid cable 23 opening and closing the bottom lid 17 includes speed and tension control. A series of support bars 40-43, 83, 106, 114, 158, 163, 168 may be positioned inside the storage container 16, and the system of this disclosure includes routing the lid cable 23 around support bars for added tension control on the cable connected to the bottom lid.

The system includes appropriate electronics and communications hardware, particularly wireless communications hardware. An electronic hardware configuration 53, 86, 89, 166, 171 is used to control mechanical operations of the storage container 16 as well for accepting wireless commands from a handheld wireless controller 29 to open and close the storage container 16 or even turn the charging controller 2 on and off. In non-limiting examples, one electronic hardware configuration 53, 86, 89, 166, 171 includes a lid raise switch 53, a limit switch 86, a limit switch lever arm 161 actuator 87, a proximity switch 89, a limit switch for lid position 166, and a limit switch for disabling lid motion 171 (i.e., ensuring that the entire system is off). The status of these components may be used to control indicator lights 26, including indicator light 172 for lid position and indicator light 173 for the lid being disabled. Other lights may be used for showing that an active charging operation is ongoing, that the system is off, etc.

The figures illustrate numerous embodiments of the bottom lid 17 in an open, downward position that makes a charging cable 3, 5 accessible to be moved toward an electric vehicle (EV) to be charged. Other figures show numerous embodiments in which the bottom lid 17 is stationary, but the storage container 16 defines a payout aperture 121 through which the charging cable 3, 5 extends for use. The charging cable 3, 5 may have multiple portions but in some embodiments, at least a portion of the charging cable 3, 5 is a spiral charging cable 3. The spiral charging cable 3 is particular suited for re-coiling the charging cable 3, 5 into the storage container 16, as the spiral body of the charging cable 3, 5 naturally returns to its shorter length and compressed state (i.e., with spiral loops closer to each other as opposed to being stretched out to a straighter shape). The spiral charging cable 3 may be accompanied by an elastic cord 66 positioned within or at least alongside the spiral charging cable 3 to provide more retraction tension that is biased to coil the charging cable 3, 5 back up. When the charging cable 3, 5 is coiled back up to be positioned back into the storage container, at least one charging cable 3, 5 stay apparatus is available inside the storage container 16 to hold the charging cable 3, 5 inside the storage cable so that the charging cable 3, 5 does not fall out when the bottom lid opens downwardly. Other embodiments utilize a straight charging cable 5 as shown in the figures.

The EV charging system can be connected to a power source 7 such as a breaker box 62 in a house or charging station, or it can be a battery operated system itself. The power source connector 8 extending from the power source 7 to the charging controller 2 is connected to the storage container 16 with tension control mechanisms to avoid pulling the power source connecter away from the power source when the charging cable 3, 5 is extended. The charging system provides a convenient, clutter free way to charge an electric vehicle from above with an easy to use storage system.

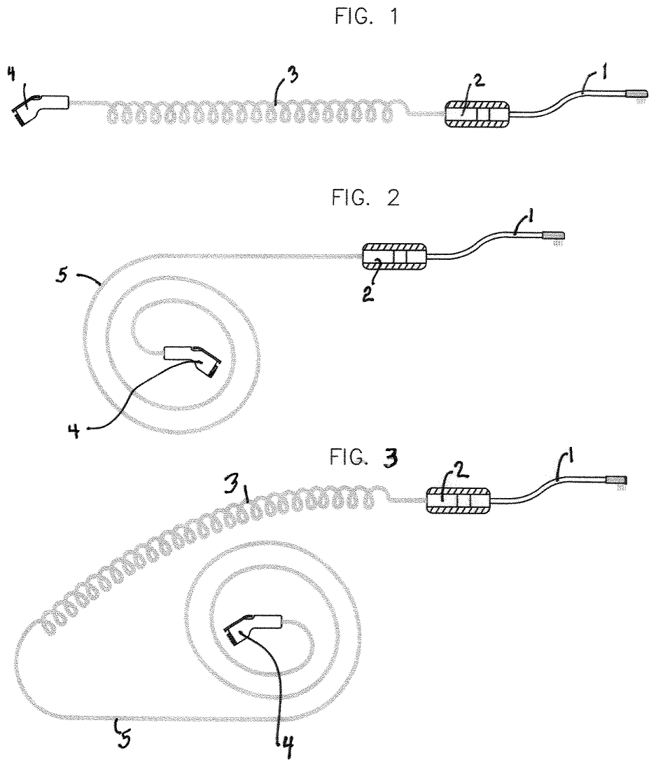

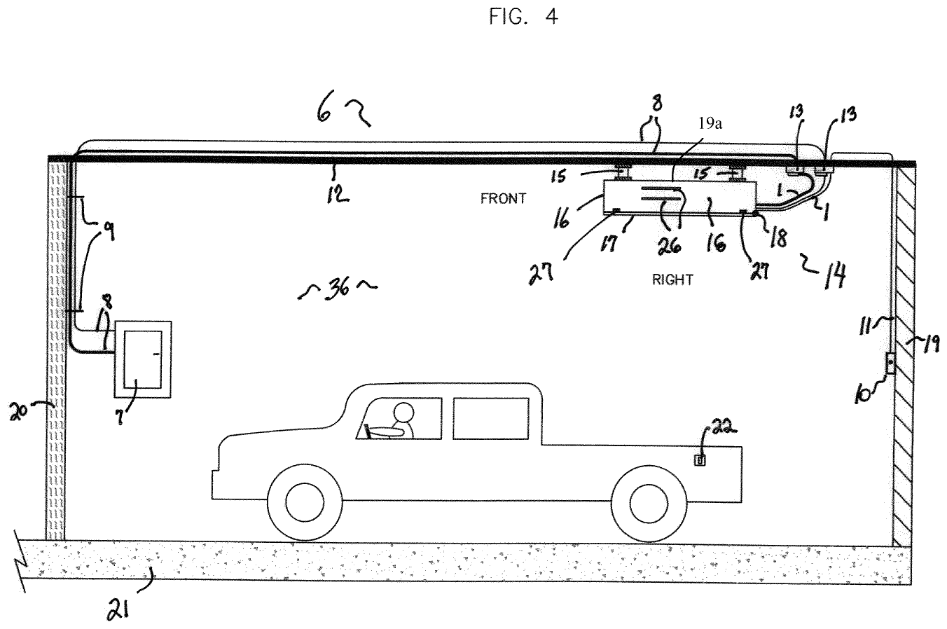

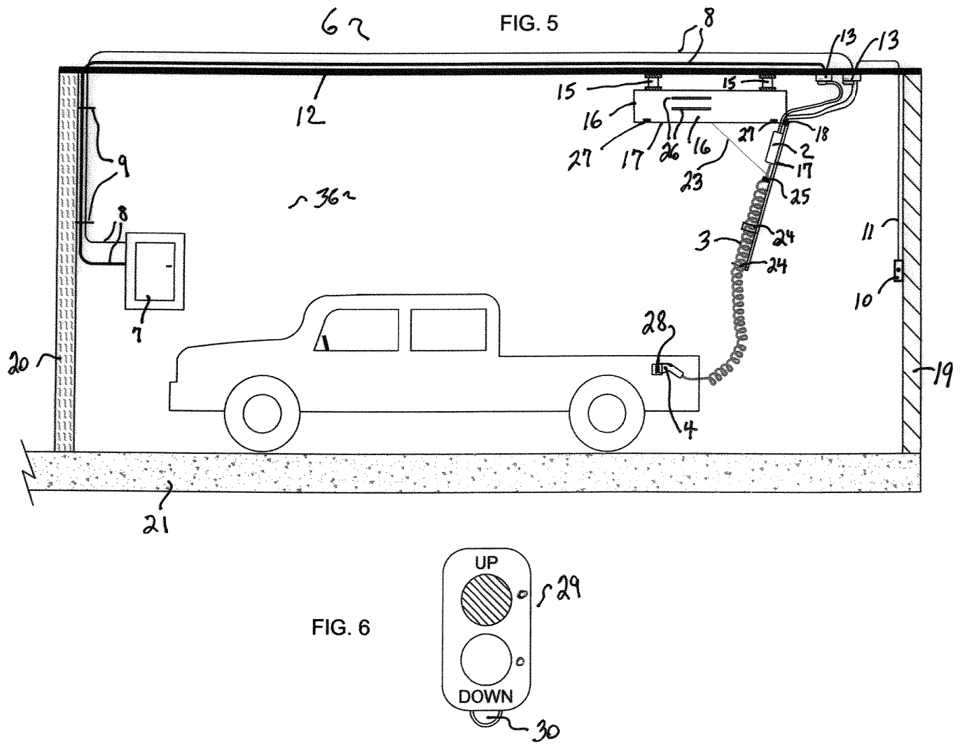

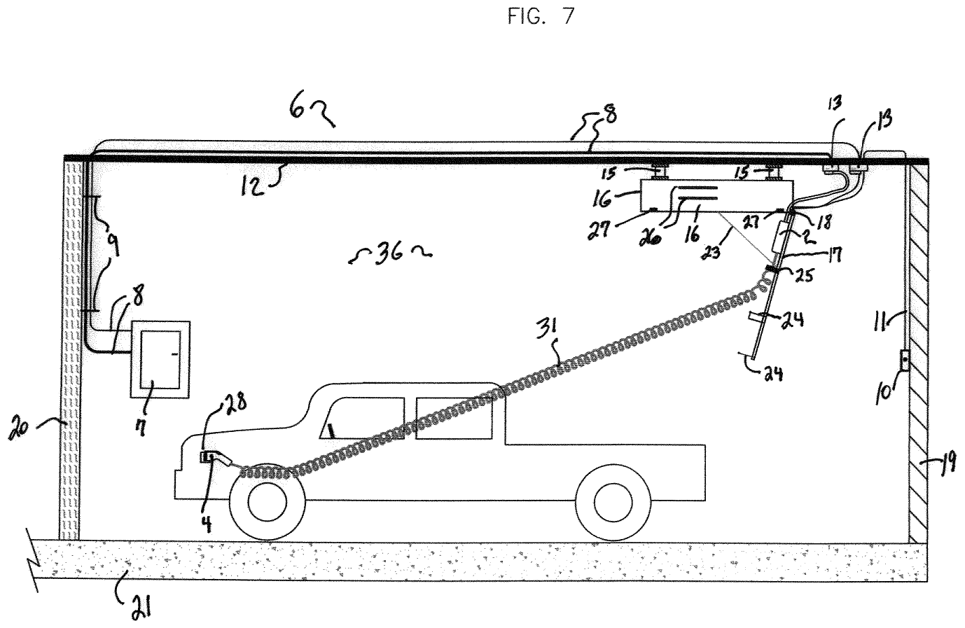

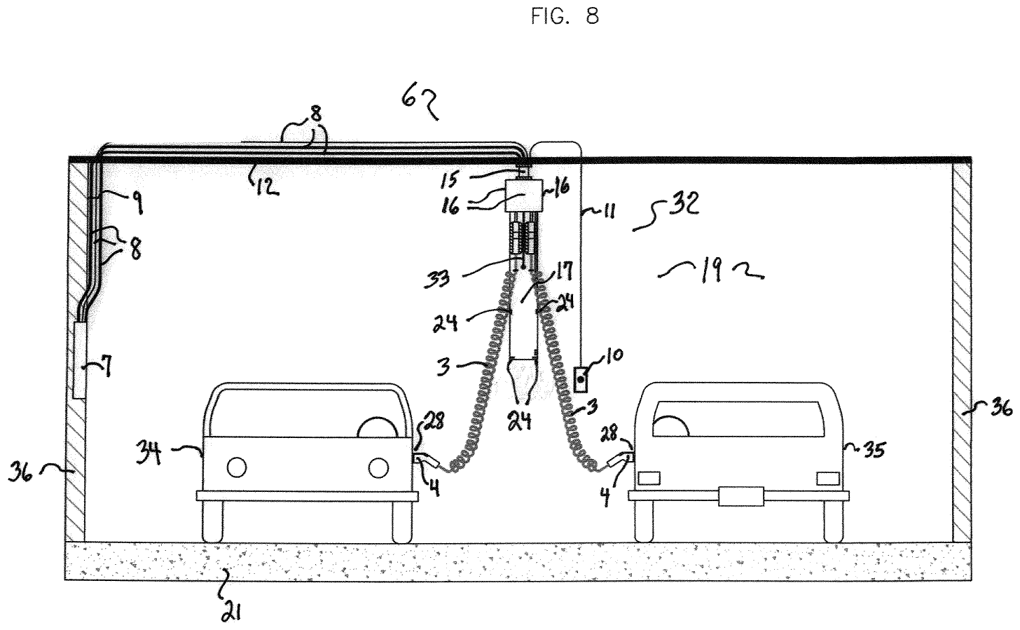

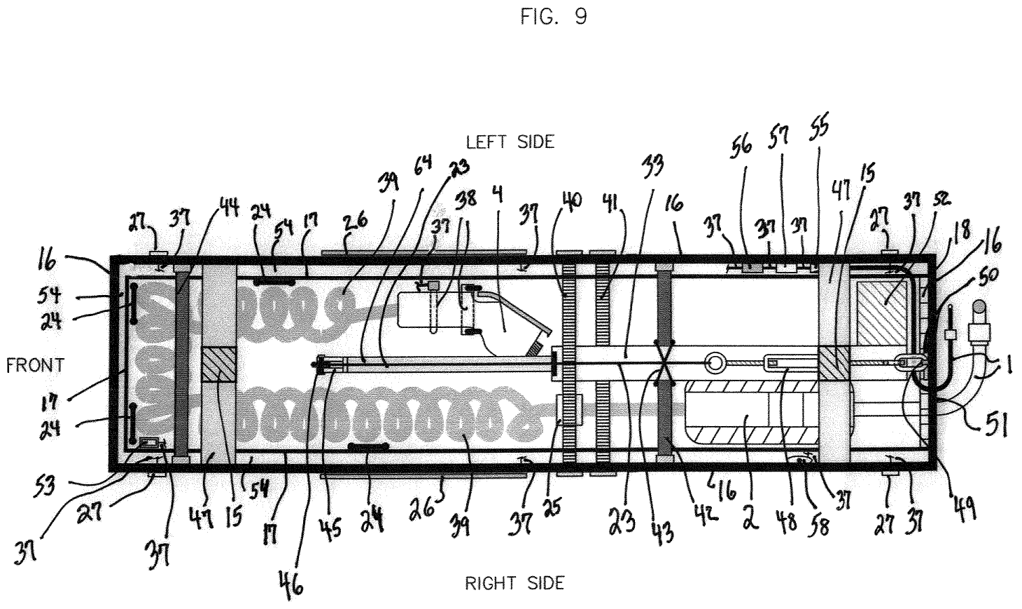

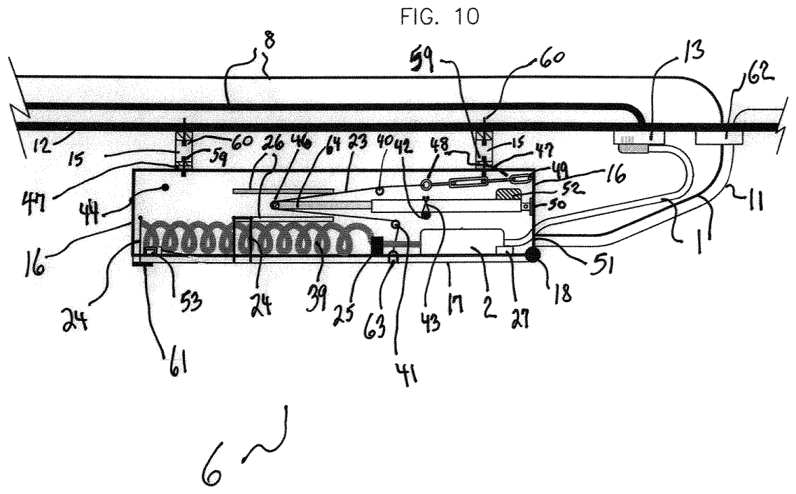

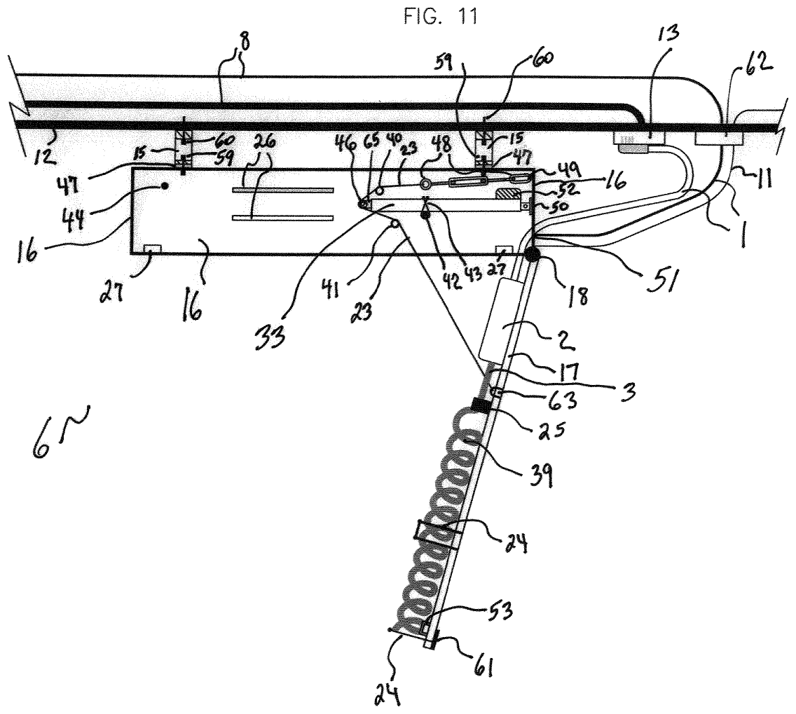

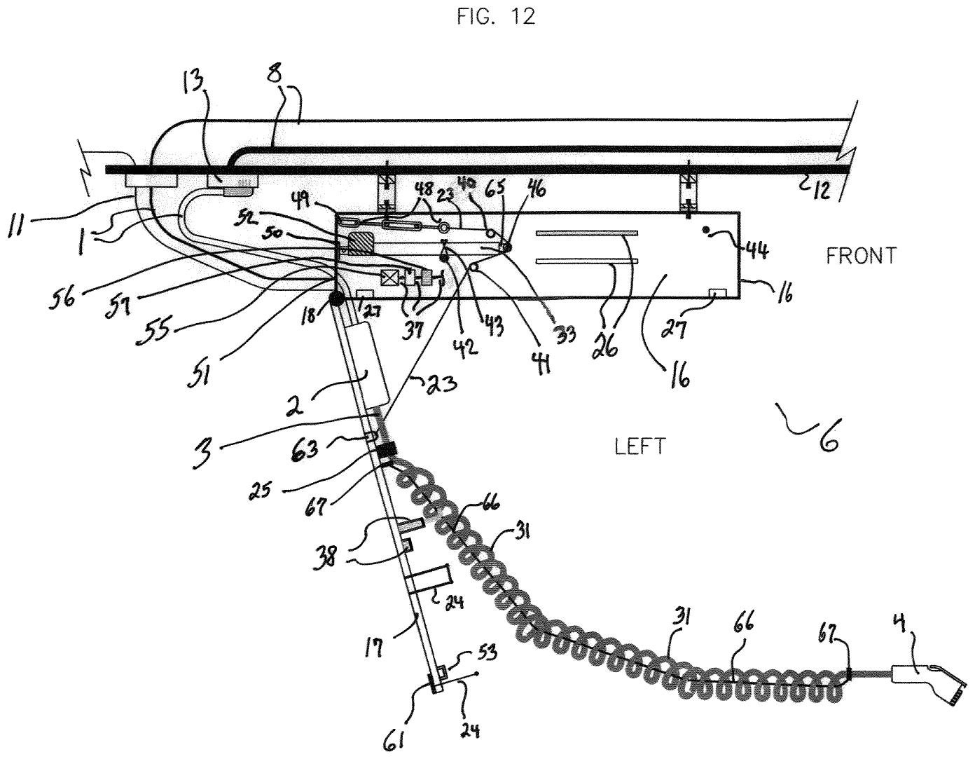

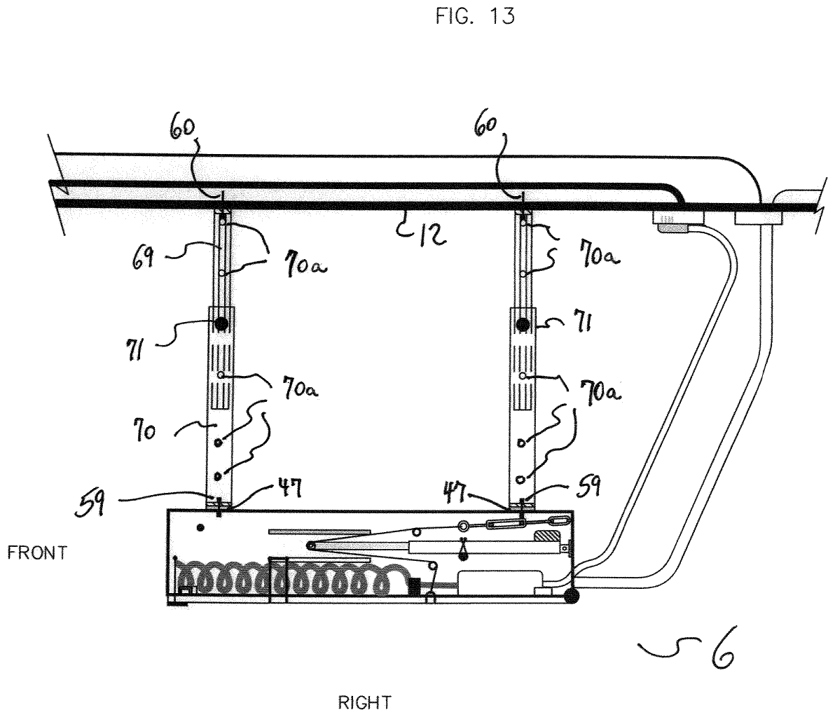

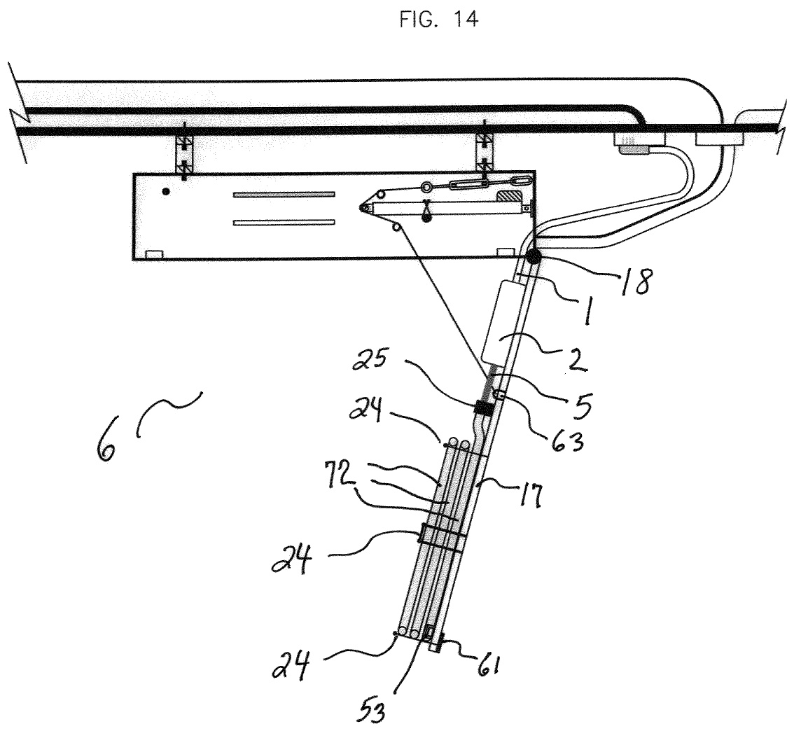

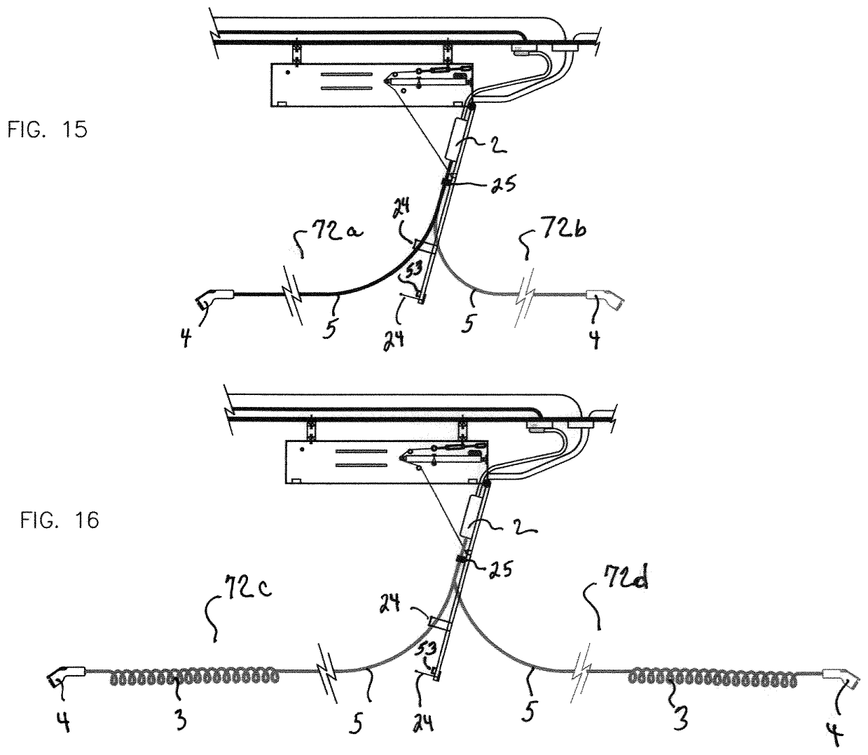

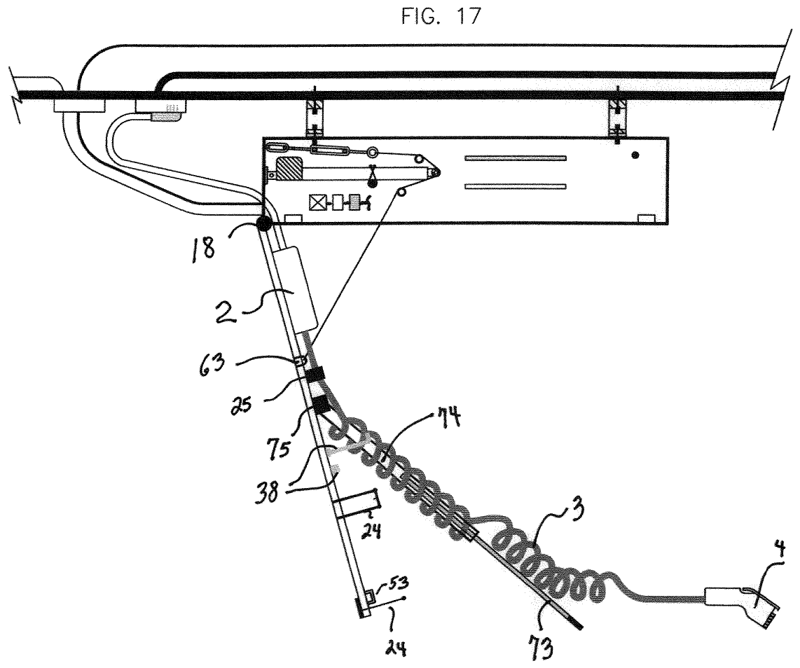

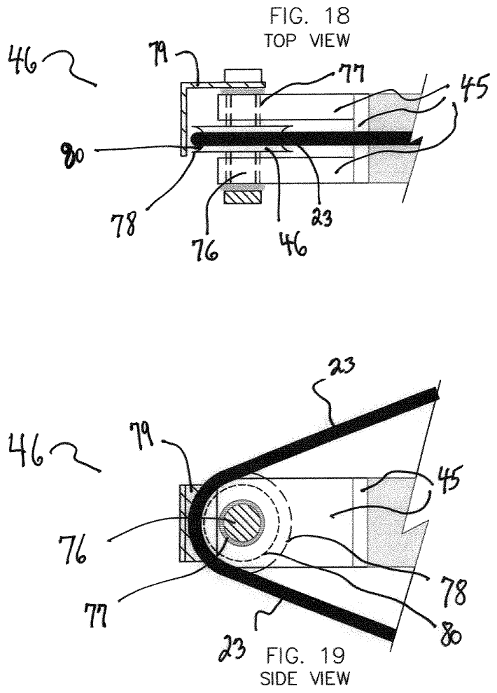

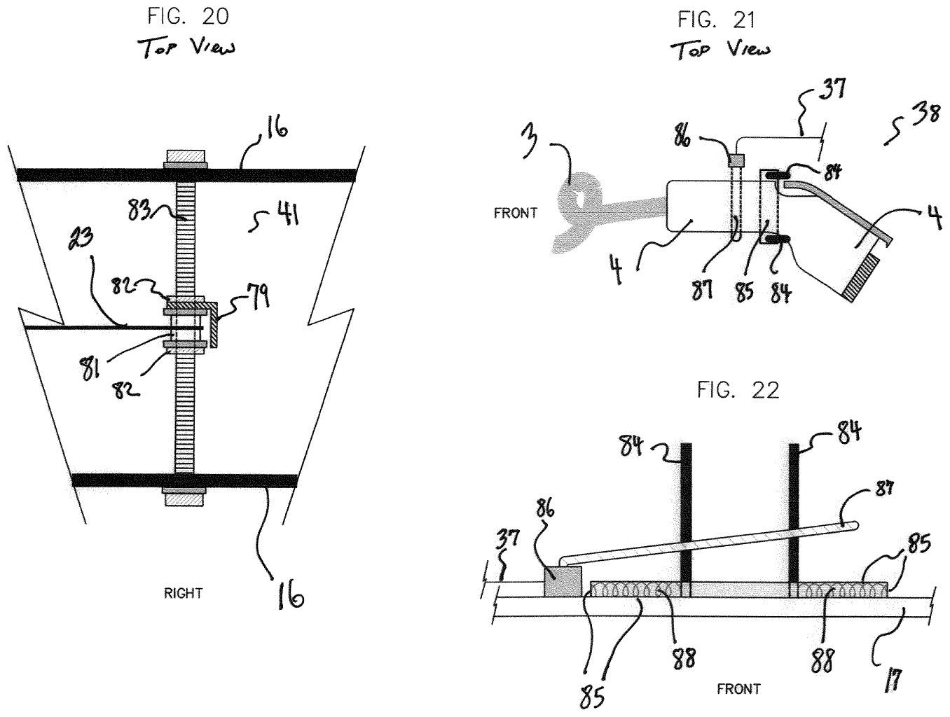

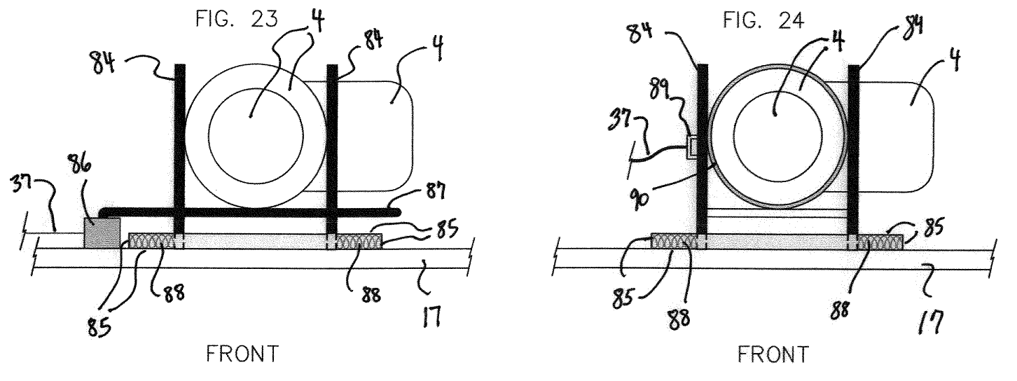

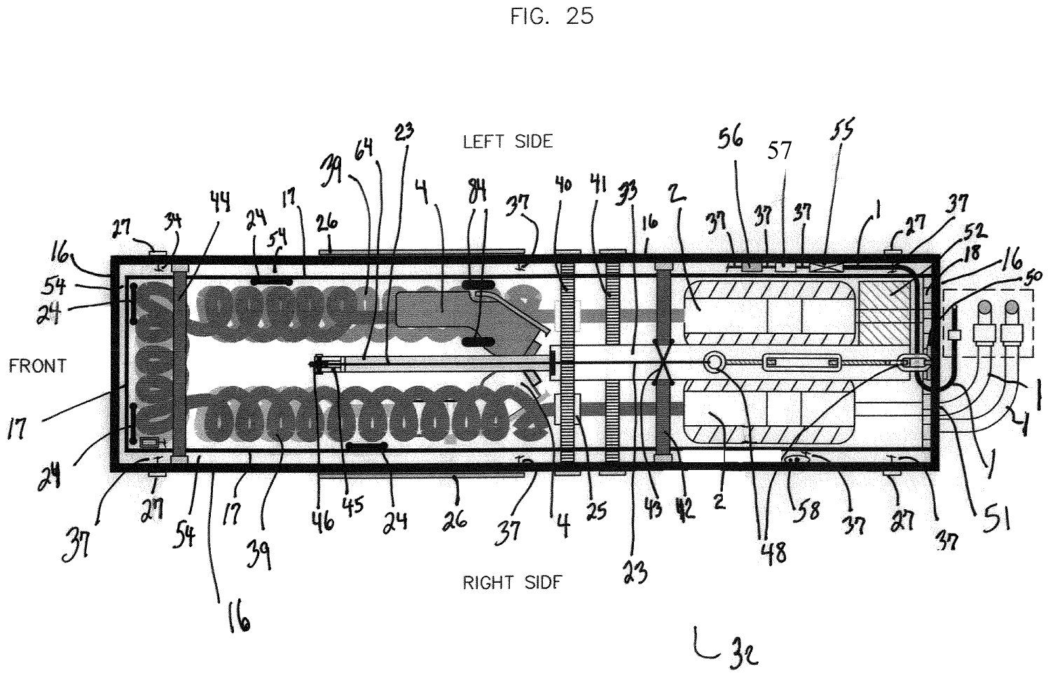

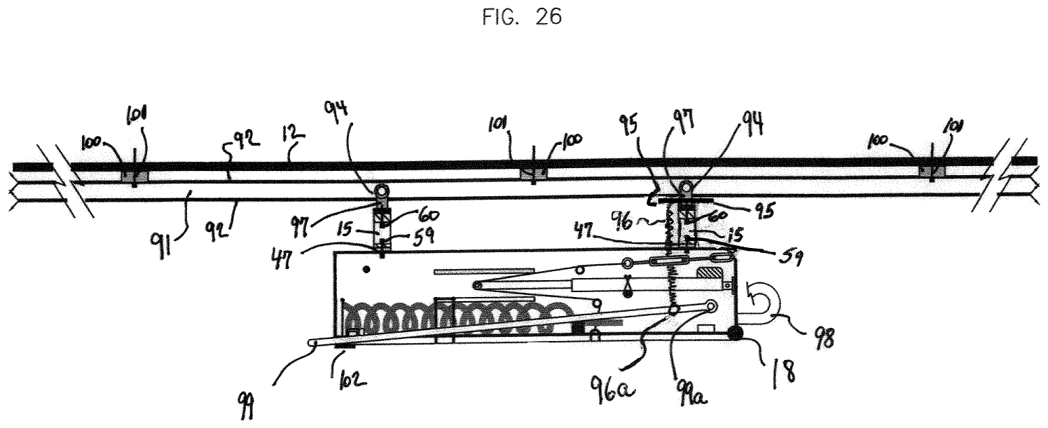

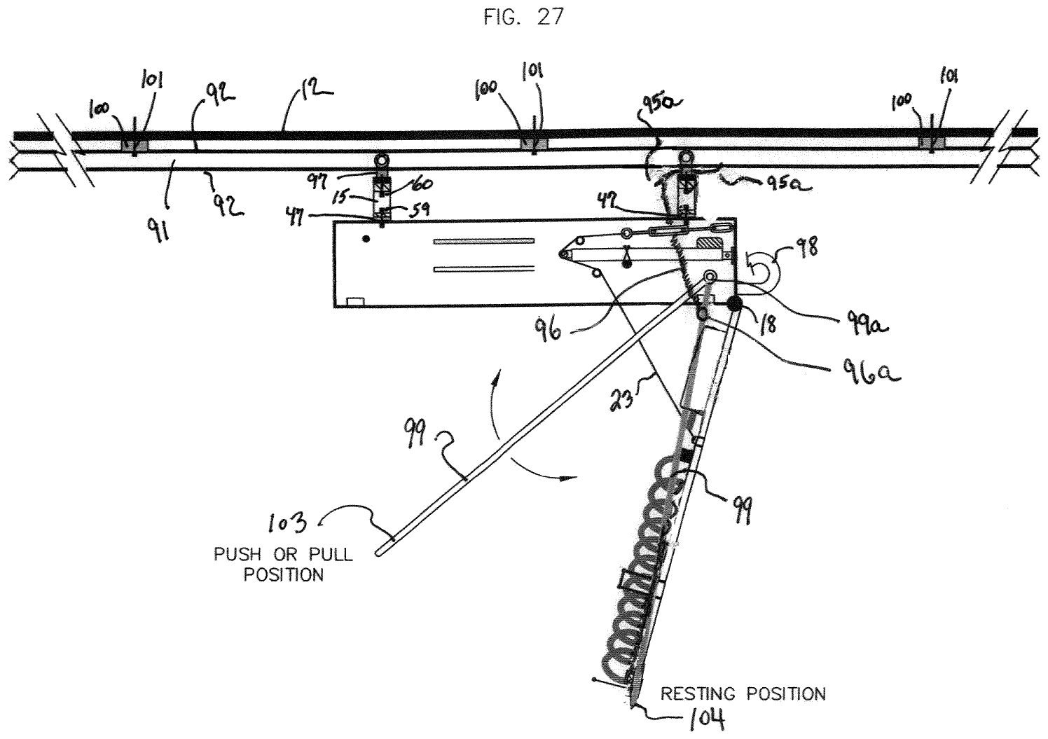

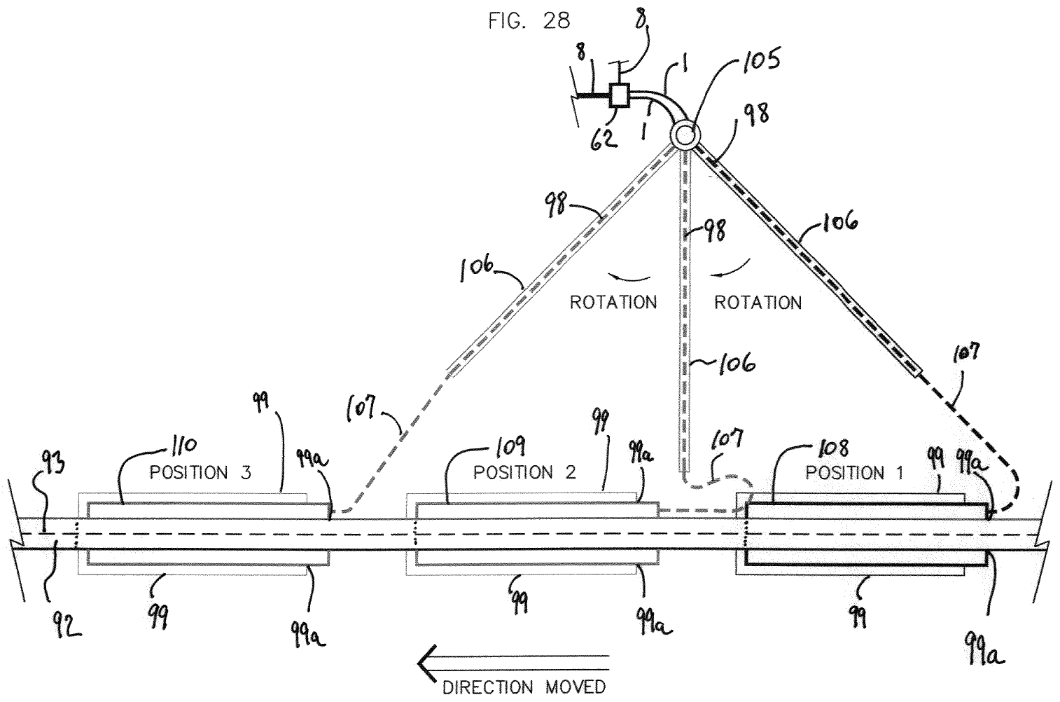

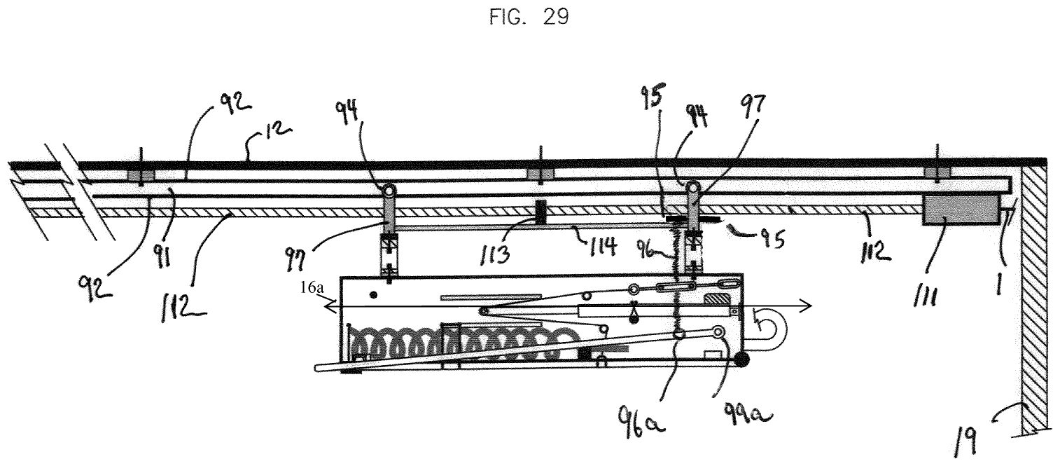

In one embodiment of this disclosure illustrated in FIGS. 1-29, a system for charging an electric vehicle includes a storage container 16 defining an interior space 16a between a first surface 19a opposite a bottom lid 17 and side walls 36 connecting the first surface 19a and the bottom lid 17. Without limiting this disclosure, the first surface may be a surface of one of the side walls, a top lid of the storage container, or even a mounting surface such as a ceiling 12 that encloses the storage container. At least one attachment mechanism 15 is connected to the storage container 16 and configured to mount the storage container 16 in an elevated position relative to a ground surface. In some embodiments, the height of the storage container 16 may be adjusted by telescoping components 69, 70, 70a. The ground surface 21 may be any surface, including but not limited to a garage floor, a parking lot, a parking place, or outside ground areas, so long as the ground surface is sufficient for an electric vehicle to park under or at least near the storage container 16. The system further includes a charging cable 3, 5 secured at least partially within the interior space 16a of the storage container 16. In some embodiments, the charging cable 3, 5 is configured to mate with or connect to a charging port on an electric vehicle. In some non-limiting embodiments, a bottom lid 17 may be connected to the storage container 16 by a hinge 18, wherein the lid is selectively opened for user access to the charging cable.

This disclosure includes embodiments in which the charging cable 3, 5 rests on a bottom lid 17 of the storage container 16, which may or may not be attached to the storage container 16 by a hinge 18. In non-limiting embodiments, the bottom lid 17 opens the storage container 16 via the hinge 18, or in embodiments without a hinge 18, the bottom lid 17 defines an opening, i.e., a payout aperture 121, through which the charging cable 3, 5 extends. For embodiments in which the bottom lid 17 opens to allow access to the charging cable, the system may include at least one cable stay that holds the charging cable 3, 5 in place when the bottom lid is lowered to an open position.

The charging cable 3, 5 may have numerous physical characteristics that are appropriate for charging a battery in any given environment. These physical characteristics configure the charging cable 3, 5 to transmit electrical power signals of any required voltage ratings, current ratings, and/or power ratings. In non-limiting embodiments, the charging cable 3, 5 includes numerous wire components incorporated into an outer sheath. The charging cable 3, 5 may include a spiral configuration to shorten the charging cable 3, 5 for storage in the storage container, and in other non-limiting embodiments, an elastic component may be attached to the charging cable 3, 5 and/or the sheath. The elastic component may be biased to coil the charging cable 3, 5 into a shorter length for storage in the storage container.

In some embodiments, the storage container 16 is configured to open via the bottom lid to make the charging cable 3, 5 accessible to a user and movable to an electric vehicle charging port 22. A charging gun 4 may be connected to the charging cable 3, 5, wherein the charging gun 4 is configured to connect to a charging port of a vehicle, allowing the system to charge a battery in the electric vehicle or within other items having a re-chargeable battery. For embodiments in which the charging cable 3, 5 includes a charging gun 4 that connects to a charging port of an electric vehicle or other battery, a holster 38 may be connected to the storage container 16 for securing the charging gun 4. In some embodiments, the holster 38 is connected to the bottom lid and is accessible by a user when the bottom lid lowers from a hinge 18, toward a ground surface 21 (e.g., a charging station floor), with the hinge 18 connected to one of the sidewalls of the storage container. In non-limiting embodiments, the holster 38 and the charging gun 4 are configured to secure to each other to retain the charging gun 4 within the holster 38, and thereby assist in retaining the charging cable 3, 5 on the bottom lid for embodiments that have a movable bottom lid. Securing the charging gun 4 to the holster 38 may be accomplished with magnets, electromagnets 142, or even mechanical clips and fasteners. For embodiments in which the bottom lid 17 does not open, a holster 38 may not be required but can be an optional accessory attached to the system outside of the storage container 16.

As noted above, certain non-limiting embodiments utilize a rotating, or pivoting, bottom lid 17 attached to a hinge 18 that is, in turn, connected to the storage container 16. The bottom lid 17, therefore is openable and closeable to allow access to the interior of the storage container 16 and to store the charging cable 3, 5 within the storage container. For embodiments with an openable bottom lid 17, an automated actuator 33 may be connected to the storage container 16 and the bottom lid 17, wherein the automated actuator 33 is configured to open and/or close the bottom lid. The automated actuator 33 or even a different motorized connection to the bottom lid may be configured to open and/or close the bottom lid. As shown in the figures, a lid cable is connected to the bottom lid 17, wherein the lid cable maintains contact with the automated actuator 33 to open or close the bottom lid. In non-limiting embodiments, the lid cable and the actuator 33 provide a designated ratio of lid movement distance relative to a length of the lid cable extending from the automated actuator 33.

Turning to additional aspects of this disclosure, the system may include a charging controller 2 connecting the charging cable 3, 5 to a power source. The charging controller 2 may be positioned within, on, or proximate to the storage container 16 and still be within the scope of this disclosure. The system further includes at least one electronic hardware configuration 53, 86, 89, 166, 171 that implements data commands. In non-limiting embodiments, the system may include electronic hardware configurations 53, 86, 89, 166, 171 that are part of an overall control system of numerous switching components, or even part of a computer having at least one processor and computerized memory that stores software and operational data. In any event, the automated actuator 33 may be connected to the bottom lid and in data communication with the electronic hardware configuration.

One function of the automated actuator 33 is to open and close the bottom lid 17, and in other embodiments, the automatic actuator 33 can be used to raise and lower the charging cable 3, 5 from a payout aperture 121 in the storage container. For the former embodiment with a selectively openable bottom lid 17, a lid cable connects the automated actuator 33 to the bottom lid to open and close the bottom lid. In the other embodiment, a retractor line 148 may be connected to the charging cable 3, 5 and moved relative to the storage container 16 with the actuator 33 operating on the retractor line. The retractor line 148, therefore, may be extended and retracted by the automated actuator 33 to position the charging cable 3, 5 and/or a charging gun 4 closer to a charging port for a battery below the storage container 16 or to position the charging cable 3, 5 and/or a charging gun 4 closer to or within the storage container. The automated actuator 33 may be any actuating assembly that can accomplish the functions described herein. In some optional implementations, such as those shown in the figures, the automated actuator 33 is a linear actuator 33 connected to one of the at least one side walls 36. In other embodiments, an actuator 33 may be positioned at least partially within the interior space 16a of the storage container 16 and configured to advance the charging cable 3, 5 generally in a direction across a long axis 16a of the storage container, which correspondingly moves an end of the charging cable 3, 5 outside the storage container 16 in a direction toward the ground surface.

The system 14 of this disclosure allows for charging a battery from an overhead position, such as from a ceiling 12 of a garage or other covering under which a vehicle is positioned to receive a battery charge. The attachment mechanism 15 that allows the storage container 16 to be connected to an overhead surface, relative to the battery to be charged, includes, for example, a hanging bracket that connects the system to a ceiling 12 above the ground surface and provides for vertical adjustment in bracket length to raise or lower the height of the system. The attachment mechanism 15 may also have an end connection configured to attach to a track 91 connected to the ceiling 12 and allows the system to manually slide across the ceiling 12 in a horizontal direction. In some embodiments, the attachment mechanism 15 is automated to traverse the track 91 via a motor controlled by a computer or the electronic hardware configuration. Other embodiments may utilize a pivoting pull-push bar 99 connected to the storage compartment to allow the user to manually slide the system, including the storage container 16, across the ceiling 12 structure from the ground surface 21.

The system of this disclosure is adept at moving battery charging equipment out of the way of an electric vehicle or any other battery operated machine that requires a charge. Positioning the system, or at least the storage container 16, above the battery to be charged allows for areas around the vehicle or other machine to be clear of cables, power equipment, and other components. The system also provides mechanisms to safely and efficiently supply power to the charging cable 3, 5. The system may include, therefore, a power assembly that includes, at least in part, a charging controller 2 connecting the charging cable 3, 5 to a power source 7. The charging controller 2 may be attached to the storage container 16 at the bottom lid 17 or on one of the sidewalls 36. The power source 7 may be located in any position proximate to or even within the storage container 16 so long as the charging cable 3, 5 can effectively connect to the power source 7. The power source 7 or additional power sources 1 may be used to provide electrical power to an electronic hardware configuration 53, 86, 89, 166, 171 that implements data commands and/or to an automated actuator 33 connected to the bottom lid 17 and in data communication with the electronic hardware configuration. In some embodiments, operation data received by the electronic hardware configuration 53, 86, 89, 166, 171 is used to control the automated actuator 33 to lower and raise the bottom lid with a lid cable. In non-limiting implementations, a wireless control switch transmits the operation data in a wireless data transmission, so the system may optionally include wireless communications hardware in the electronic hardware configuration 53, 86, 89, 166, 171 that processes the operation data received in a wireless protocol. Other ways to activate the system may include a wall switch 10 and associated wall switch wire 11.

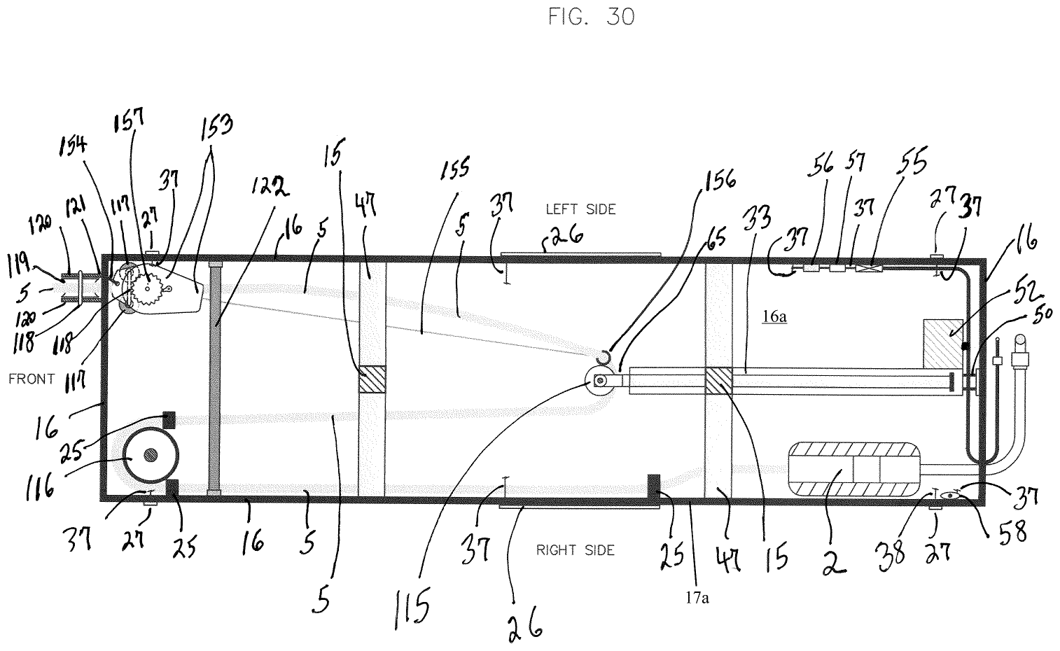

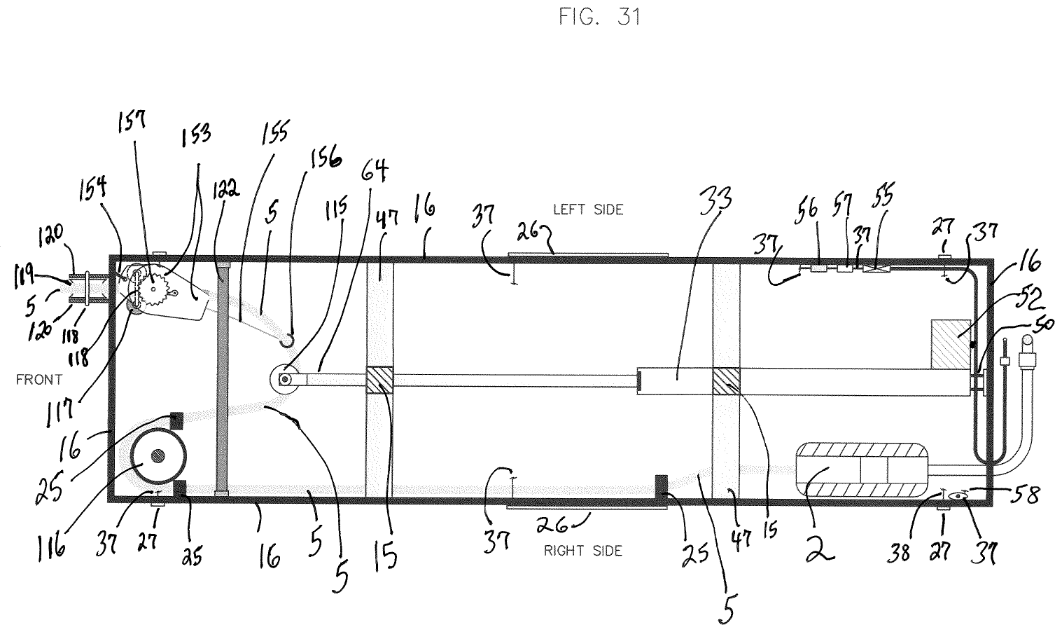

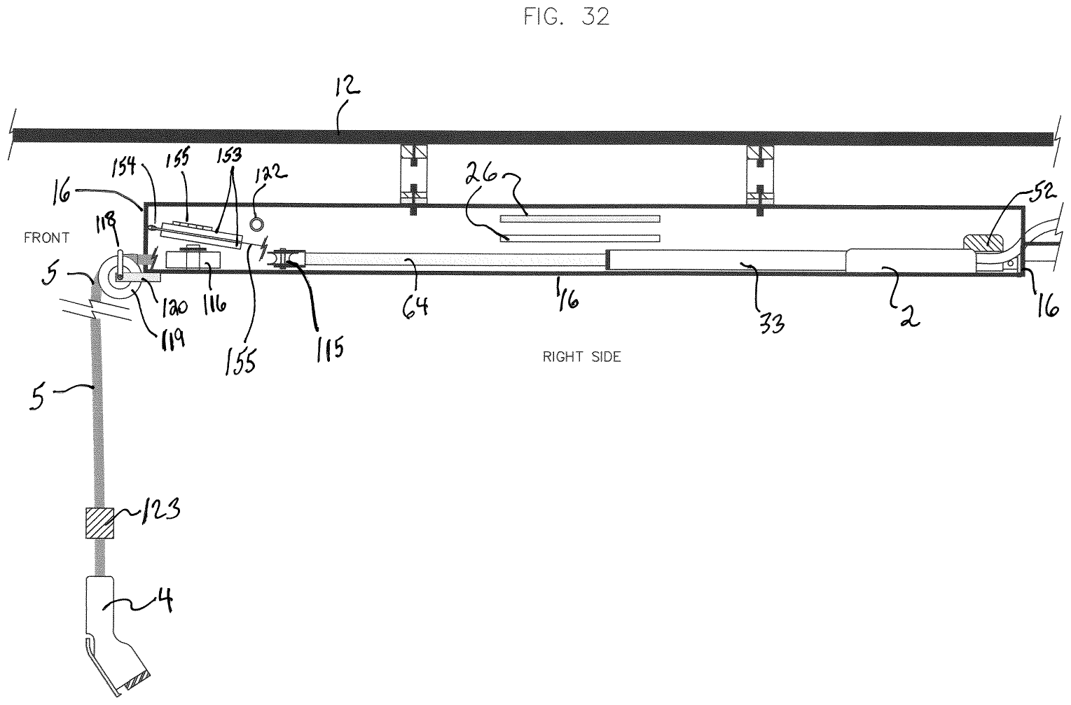

As noted above, some embodiments of this disclosure may utilize a fixed bottom lid 17 as illustrated in FIGS. 30-32, such as a bottom wall 17a, secured to the other side walls 36, and the storage container 16 in those embodiments defines a payout aperture 121 through which the charging cable 3, 5 extends for use. The payout aperture 121 may allow access to an interior space 16a of the storage container 16 through a side wall 36 or even the bottom wall 17a. In this non-limiting implementation, a system for charging an electric vehicle or any other battery operated machine may include a storage container 16 defining an interior space 16a between a bottom lid 17a and side walls 36 connecting a first surface and the bottom lid 17. At least one attachment mechanism 15 may be connected to the storage container 16 and configured to mount the container in an elevated position relative to a ground surface. A charging cable 3, 5 is secured at least partially within the interior space 16a of the storage container. An actuator 33 may be positioned at least partially within the interior space 16a of the storage container 16 and configured to advance the charging cable 3, 5 generally in a direction across a long axis 16a of the storage container 16 (i.e., from end to end of the storage container), which correspondingly moves an end of the charging cable 3, 5 outside the storage container 16 in a direction toward the ground surface 21. In other words, the actuator 33 and corresponding components in the storage container 16 are configured to move the charging cable 3, 5 through the payout aperture 121 of the storage container 16, up and down or substantially vertically, for use in charging a battery and then for storing within the storage container 16. In some embodiments, the actuator 33 may be a linear actuator 33, and the system further includes guiding components, such as but not limited to, a wheel connection around which the charging cable 3, 5 rotates as the linear actuator 33 is extended and retracted. In some non-limiting embodiments, a constant tensioning device 153 includes a retractor line 148 connected to the charging cable 3, 5, wherein the constant tensioning device 153 pulls the charging cable 3, 5 with the retractor line 148 to raise and lower the charging cable 3, 5 out of a payout aperture 121 in the storage container. The constant tensioning device 153 is connected to the storage container 16 in many embodiments. In some implementations, the constant tensioning device 153 may be configured with the retractor line 148 free to extend and then retract when the user releases the retractor line 148 (e.g., by pulling the retractor line 148 and unlocking the constant tensioning device). In other embodiments, the constant tensioning device 153 is biased to retract the line unless a user is pulling the retractor line 148 away from the constant tensioning device. Upon letting go of the retractor line, the constant tensioning device 153 automatically recoils the retractor line 148 to move the charging cable 3, 5 back into the storage device. The charging cable 3, 5 typically extends from the retractor line 148 with degrees of freedom selected from the group including forward extension, backward retraction, left movement and right movement relative to the retractor line 148 to access a vehicle's charging port. As discussed above, this embodiment also includes a charging controller 2 connecting the charging cable 3, 5 to a power source and further includes an electronic hardware configuration 53, 86, 89, 166, 171 that implements data commands, wherein the electronic hardware configuration 53, 86, 89, 166, 171 is in data communication with the actuator 33 and wherein operation data received by the electronic hardware configuration 53, 86, 89, 166, 171 is used to control the actuator 33 to lower and raise the charging cable.

Non-limiting embodiments of this disclosure include other arrangements of parts and components that have been discussed herein. For example, and without limiting this disclosure, a system for charging an electric vehicle may include a storage container 16 defining an interior space 16a therein and generally positioned above a ground surface on which a vehicle can park. A charging cable 3, 5 is at least partially within the interior space 16a of the storage container. The bottom lid 17 may optionally be connected to the storage container 16 by a hinge 18, wherein the bottom lid 17 is selectively opened for user access to the charging cable 3, 5. In this embodiment, a charging cable retractor assembly 146 may be positioned within the storage container 16 and connected to the charging cable 3, 5, wherein the charging cable retractor assembly selectively allows the charging cable 3, 5 to extend away from the bottom lid 17 for charging and retract into the storage container 16 for storage. Similar to embodiments already described, a retractor line 148 is extendable and retractable from the charging cable 3, 5 retractor assembly and connected to the charging cable. The retractor line 148 may be moved to an extended position to move the charging cable 3, 5 to a suspended position when the bottom lid opens, and the retractor line 148 may be moved to a retracted position that holds the charging cable 3, 5 proximately to the bottom lid in a closed position.

This disclosure includes any apparatus for storing a charging cable 3, 5, particularly but not exclusively, for storing a charging cable 3, 5 in an overhead position relative to a battery that needs to be charged. In non-limiting examples, a retractor line 148 may be connected to the charging cable 3, 5, which in turn is secured temporarily to the bottom lid of the storage container. In use, the bottom lid moves to an open position, and the charging cable 3, 5, along with any associated charging gun 4, can be detached from the bottom lid for use, and then reattached to the bottom lid for storage. In example embodiments, the bottom lid and the charging cable 3, 5 may be attached and detached mechanically (e.g., with a cable stay 24 or charging cable fastener 25) and/or magnetically. In this example, by moving the retractor line 148 that is directly connected to the charging cable 3, 5, the bottom lid of the storage container, secured to charging cable 3, 5 moves as well.

Generally, and without limitation, the apparatus of this example includes a storage container 16 defining an interior space 16a within a plurality of side walls; a bottom lid connected to one of the side walls; and a hinge 18 connecting a first end of the bottom lid to the one of the side walls. A charging cable 3, 5, that fits within the interior space 16a of the storage container, connects to the bottom lid with a securing assembly that allows for the charging cable 3, 5 to be attached to or detached from the bottom lid. In non-limiting embodiments, the securing assembly can be any kind of fastener or retention clip that connects wherein the charging cable 3, 5 is further connected to a power assembly. In this embodiment, a retractor line 148 is extendable and retractable from a charging cable 3, 5 retractor assembly secured within the storage container 16 and connected to the charging cable. The retractor line 148 includes an extended position to move the charging cable 3, 5 and the bottom lid 17 to a suspended position when the bottom lid opens, and the retractor line 148 includes a retracted position that holds the charging cable 3, 5 and the bottom lid in a closed position. As discussed above, a power assembly connected to the apparatus includes a charging controller 2 connecting the charging cable 3, 5 to a power source 7 with the power assembly.

To move the charging cable 3, 5 and the bottom lid 17 in one motion, a retractor actuator assembly 33 is connected to the retractor line 148 to extend and retract the retractor line 148 from the charging cable retractor assembly. The retractor actuator assembly 33, connected to the retractor line 148, includes a motor and a retractor line 148 wheel that extends and retracts the retractor line 148 from the charging cable 3, 5 retractor assembly to open and close the bottom lid for access to the charging cable. In some embodiments, the apparatus may also incorporate a lid cable connected to the bottom lid and an automated lid actuator 33, wherein operation data received by electronic hardware assembly is used to control the automated lid actuator 33 to lower and raise the bottom lid with the lid cable 23. As mentioned above, an electronic hardware assembly that implements data commands is in data communication with the actuator 33 assembly to open and close the bottom lid via the retractor line, the lid cable, or both.

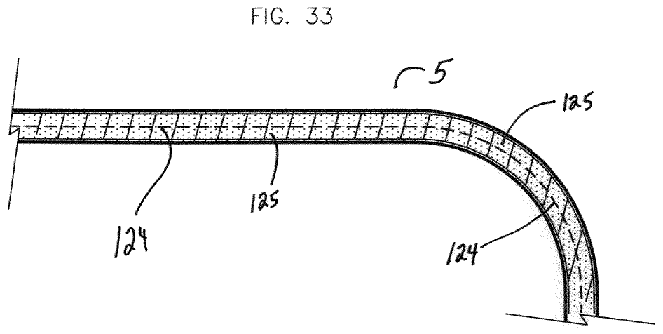

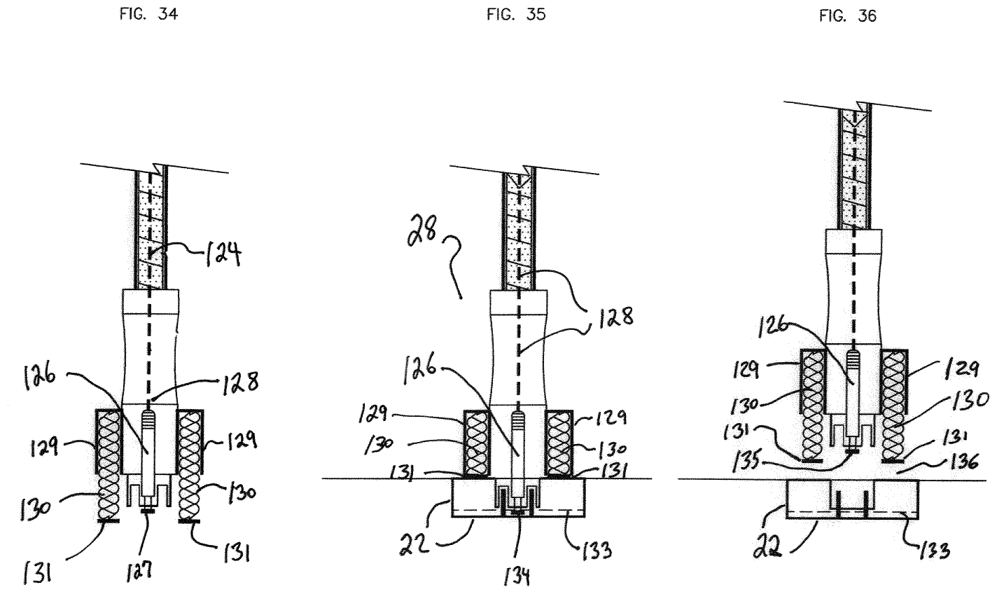

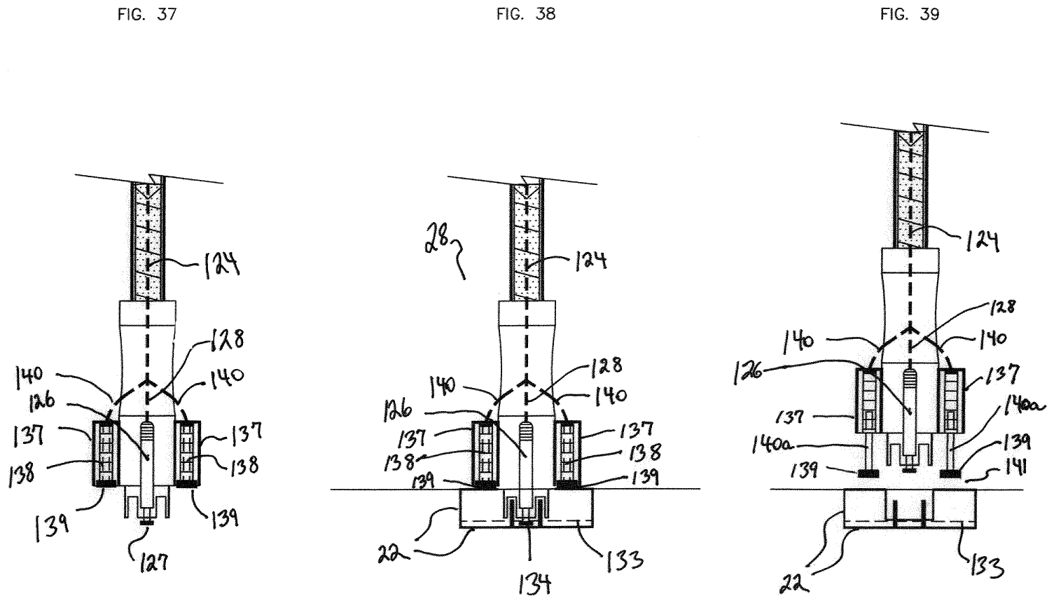

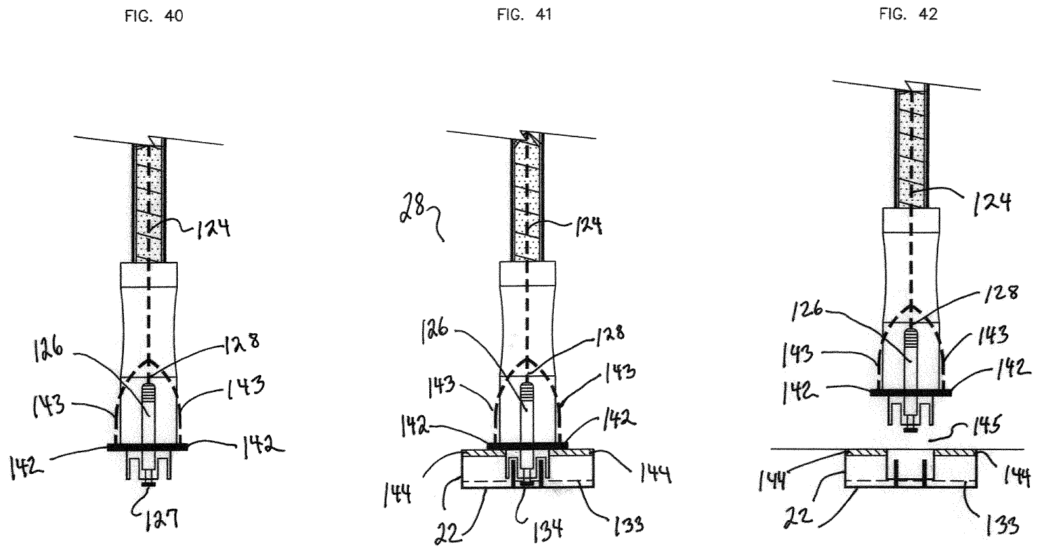

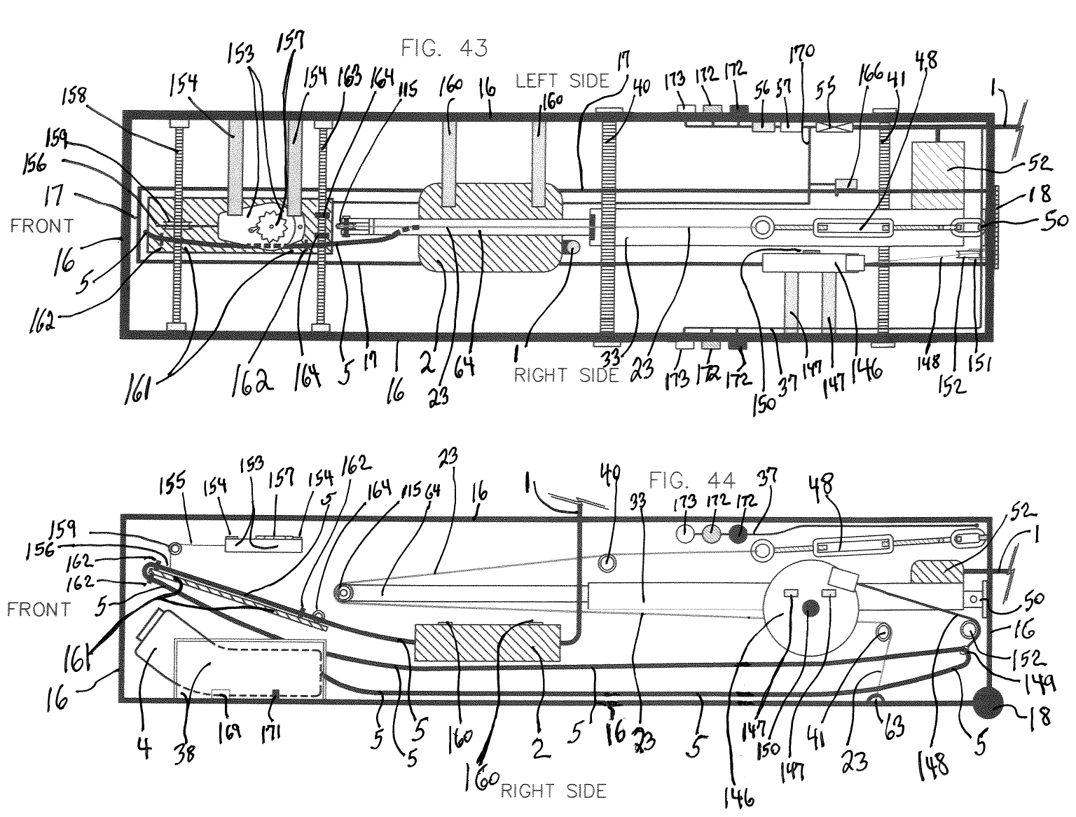

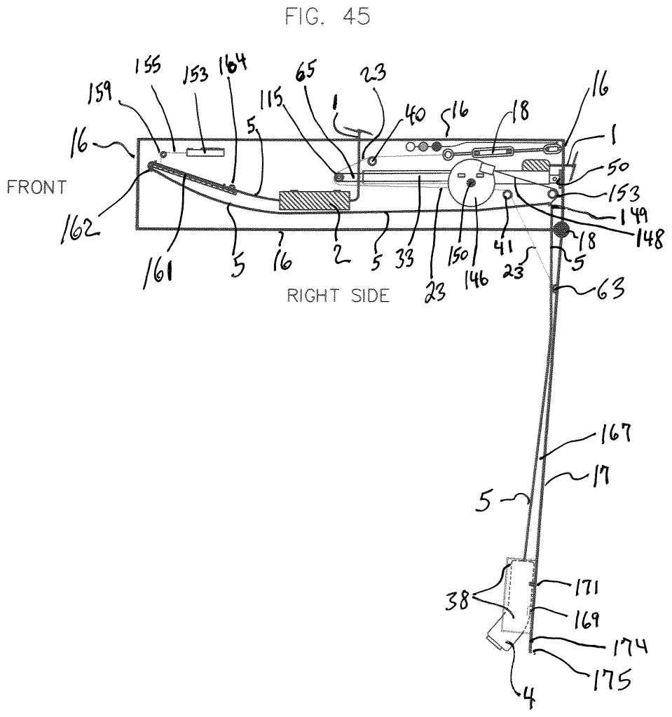

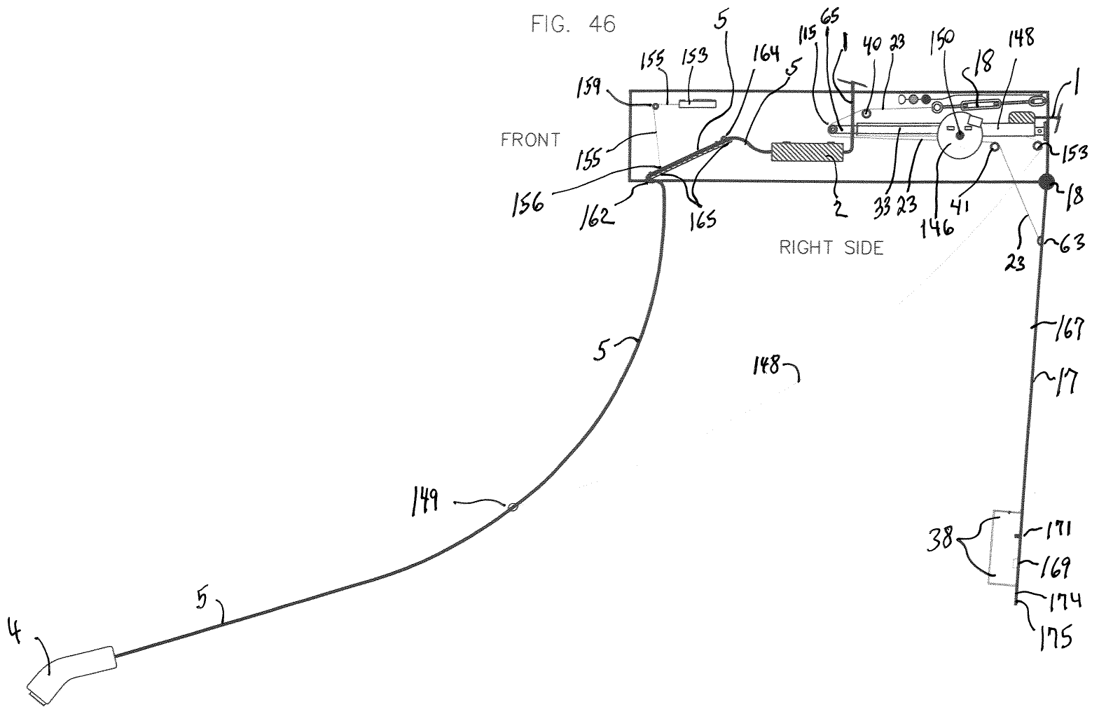

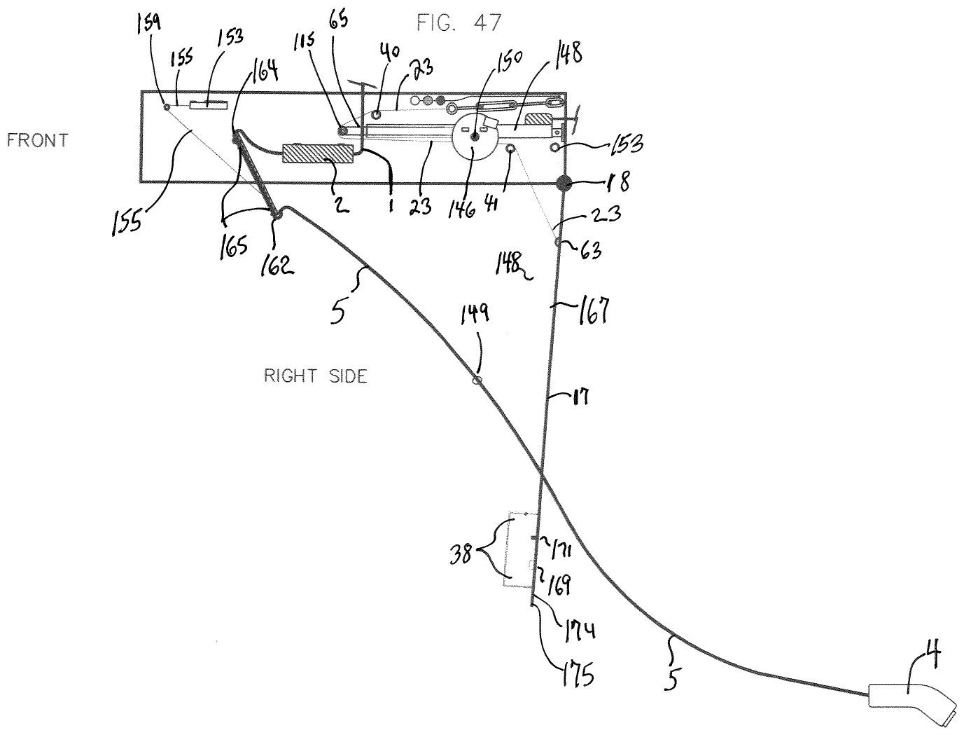

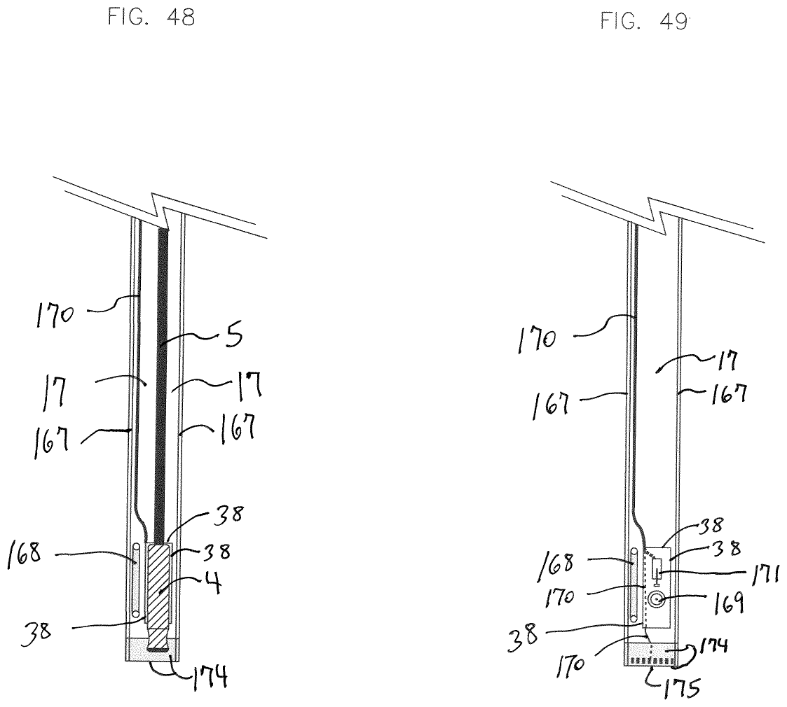

Some embodiments of this disclosure, as shown in FIGS. 33-49, include additional components to manage the position, the tension, and the maneuverability of the charging cable 3, 5 that extends from the storage container 16 (either from a bottom lid or from a payout aperture 121). In one non-limiting embodiment, a rotating lever arm 161 is connected inside the storage container 16 with a second hinge 18 connected to the storage container. A tensioning device line is connected to the rotating lever arm 161 at a position separated from the second hinge 18, and a constant tensioning device 153 is secured within the storage container 16 and connected to the tensioning device line, wherein the rotating lever arm 161 supports a portion of the charging cable 3, 5 extending from the storage container. The rotating lever arm 161 may include an extended position that partially supports the charging cable 3, 5 during operation of the bottom lid 17, and wherein a position of the rotating lever arm 161 determines an angle at which the charging cable 3, 5 can be extended off of the bottom lid.

The embodiments described herein include a system for charging an electric vehicle and include a storage container 16 defining an interior space 16a therein; a bottom lid connected to the storage container 16 by a hinge 18; a charging cable 3, 5 that fits within the interior space 16a of the storage container; a charging controller 2 connecting the charging cable 3, 5 to a power source 7; and an electronic hardware assembly, such as a computer or switch assembly, that implements data commands. An automated actuator 33 is connected to the storage container 16 and in data communication with the electronic hardware assembly. A lid cable has been connected to the bottom lid 17, and if necessary, also connected to another section of the storage container. The lid cable maintains contact with the automated actuator 33, and operation data received by the computer is used to control the automated actuator 33 to lower and raise the bottom lid 17 with the lid cable 23. In use, a control switch may be used to transmit the operation data to the electronic hardware configuration. In some embodiments, a wireless control switch 29 transmits the operation data in a wireless data transmission to a wireless signal receiver 57. Wireless communications hardware 57 connected to the electronic hardware configuration 53, 86, 89, 166, 171 processes the operation data received in a wireless protocol. In some embodiments, the charging controller 2 is attached to the bottom lid 17, and in other embodiments, the storage container 16 further comprises at least one side wall to which the charging controller 2 is attached. A top section 19a of the storage container 16 may be positioned oppositely from the bottom lid and across the interior space 16a. For embodiments in which the system includes the storage container 16 in an overhead position, an attachment mechanism 15 is connected to the storage container 16 and to a ceiling 12 surface having a height dimension that provides clearance for the bottom lid to open at the hinge 18. For use in charging a vehicle or other battery in a machine below the storage container, a power source will be connected to the charging controller 2 and/or the charging cable 3, 5 itself. The rotating lever arm 161 described above may also be connected to this embodiment. The rotating lever arm 161 may be generally positioned substantially inside the storage container 16 with a second hinge 18, wherein the rotating lever arm 161 supports a proximal portion of the charging cable 3, 5, relative to the storage container, during operation of the bottom lid 17, and wherein a position of the rotating lever arm 161 determines an angle at which the charging cable 3, 5 can be extended away from the bottom lid.

For purposes of this disclosure, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature

The present disclosure has been described with reference to example embodiments, however persons skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability.

Accordingly, all such modifications are intended to be included within the scope of the present disclosure. Other substitutions, modifications, changes and omissions may be made in the design, operating conditions and arrangement of the preferred and other exemplary embodiments without departing from the spirit of the present subject matter.

In example implementations, at least some portions of the activities may be implemented in software provisioned on a networking device. In some embodiments, one or more of these features may be implemented in computer hardware, provided external to these elements, or consolidated in any appropriate manner to achieve the intended functionality. The various network elements may include software (or reciprocating software) that can coordinate image development across domains such as time, amplitude, depths, and various classification measures that detect movement across frames of image data and further detect particular objects in the field of view in order to achieve the operations as outlined herein. In still other embodiments, these elements may include any suitable algorithms, hardware, software, components, modules, interfaces, or objects that facilitate the operations thereof.

Furthermore, computer systems described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that single processor and a single memory element are responsible for certain activities. In a general sense, the arrangements depicted in the Figures may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory can store data used for the operations described herein. This includes the memory being able to store instructions (e.g., software, logic, code, etc.) in non-transitory media, such that the instructions are executed to carry out the activities described in this Specification. A processor can execute any type of computer readable instructions associated with the data to achieve the operations detailed herein in this Specification. In one example, processors (e.g., processor) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Aspects of this disclosure shown in the figures include the following components:

### Element

### Number Element Name

1 power cable
2 charging controller
3 spiral charging cable
4 charging gun
5 straight charging cable
6 charging station
7 power supply source
8 power source cable
9 cable to wall fastener
10 wall switch
11 wall switch wire
12 charging station ceiling
13 electrical outlet
14 EV charging system
15 hanging bracket
16 storage container
17 pivoting bottom lid
18 bottom lid hinge
19 charging station rear wall
20 vehicle access opening
21 ground surface
22 vehicle charging port
23 active lid cable
24 charging cable stay
25 charging cable fastener
26 LED Indicator light
27 vehicle presence detector
28 charging gun connected in EV port
29 wireless controller
30 key chain connector
31 extended spiral cable
32 dual EV charging system
33 linear actuator
34 vehicle backed in
35 vehicle pulled in
36 charging station side wall
37 wire group
38 charging gun holster
39 stored spiral cable
40 upper lid cable support bar
41 lower lid cable wheel and support bar
42 actuator horizontal support bar
43 actuator support bar fastener
44 power cable consolidation Bar
45 actuator rod end bracket
46 rod end vertical cable wheel
47 top horizontal bracket connection plate
48 lid cable turnbuckle
49 turnbuckle end connection
50 actuator end connection
51 system frame opening
52 actuator motor
53 lid raise switch
54 lid clearance to exterior frame
55 DC power supply
56 controls box
57 wireless signal receiver
58 audible annuciator
59 bracket to plate fastener
60 bracket to ceiling fastener
61 rubber protection pad
62 electrical junction box
63 cable to lid connector
64 extended actuator rod position
65 retracted actuator rod position
66 inner elastic cord
67 inner elastic chord fastener
68 telescoping vertical connection bracket
69 inner telescoping bar
70 outer telescoping tube
70a telscoping pin holes
71 removable telescoping pin
72 charging cable in stored position
72a front straight charging cable
72b rear straight charging cable
72c front straight and spiral charging cable
74d rear straight and spiral charging cable
73 tilt-swivel telescoping bar
74 tilt-swivel telescoping outer tube
75 tilt-swivel device
76 bolt
77 bearing sleeve
78 cable wheel outside diameter
79 cable stay
80 cable wheel inner groove bottom
81 lower lid cable wheel
82 adjustable frasteners for wheel positioning
83 lid cable support bar
84 holster charging gun stay pin
85 holster bottom tube bracket
86 limit switch
87 limit switch lever arm activator
88 holster compression spring
89 proximity switch
90 proximity switch activation trigger
91 I-Beam track
92 I-Beam flange
93 I-Beam web
94 trolley wheel assembly
95 trolley wheel brake
95a trolley brake pressed
96 trolley brake activation cord
96a brake cord fastener
97 trolley wheel connection bracket
98 consolidated power cable
99 rotating pull-push bar
99a rotating bar pivot point
100 I-Beam-ceiling connection bracket
101 I-Beam to ceiling fastener
102 rotating pull-push bar stay
103 rotating bar in push-pull position
104 rotating bar in resting position
105 rotating ceiling connector
106 power cable support casing
107 power cable extention from casing
108 EV charging system positioned at right
109 EV charging system positioned at center
110 EV charging system positioned at left
111 linear motion motor
112 threaded rod
113 ball screw
114 ball screw support bracket
115 rod end horizontal cable wheel
116 fixed charging cable guide
117 charging cable horizontal guide wheels
118 charging cable stay
119 exterior cable drop wheel
120 exterior wheel connection bracket
121 payout aperture
122 longitudinal horizontal roller stay
123 adjustable counter weight
124 exterior flexible wire group
125 exterior protective cable wrap
126 charging gun connection lever
127 connection lever end lip
128 charging gun lever release wire
129 compression spring casing
130 compression spring in extended position
131 compression spring end
132 spring in the compressed position
133 EV port connection ridge
134 lever pin lip connected to EV port ridge
135 lever pin released from EV port ridge
136 compression spring release activated
137 plunger casing
138 plunger in the retracted position
139 plunger end
140 plunger activation wire
140a plunger extended
141 plunger release activated
142 electro-magnet
143 electro-magnetic activation wire
144 EV port magnetic plate
145 electro-magnet release activated
146 Self Locking Retractor Device
147 Mounting Bracket for Retractor Device
148 Retractor Line
149 Retractor Wire End Fastener
150 Wire Tension Adjustment Device
151 Wheel Mounting Bracket
152 Wheel Redirecting Retractor Wire
153 Constant Tensioning Device
154 Mounting Bracket for Tensioning Device
155 Tensioning Device Line
156 Tensioning Line End Fastener
157 Line Tension Adjustment Device
158 Wheel Support Bar
159 Wheel Redirecting Tensioning Line
160 Mounting Bracket for Charging Controller
161 Rotating Lever Arm
162 Fastener for Cable to Arm
163 Rotating Arm Support Bar
164 Rotating Arm Pivot Bracket
165 Rotating Arm in Pivot Position
166 Limit Switch for Lid Position
167 Lid Guard Rails
168 Support Handle
169 Charging Gun Magnetic Connection
170 Controls Wire to Holster
171 Limit Switch Disabling Lid Motion
172 LED Indicator Light for Lid Position
173 LED Indicator Light for Lid Disabled
174 Rubber Protection Cover
175 Bump Sensor Reversing Lid Motion

1. A system for charging an electric vehicle, the system comprising:
a storage container defining an interior space between a first surface opposite a bottom lid and side walls connecting the first surface and the bottom lid;
at least one attachment mechanism connected to the storage container and configured to mount the storage container in an elevated position relative to a ground surface;
a charging cable secured at least partially within the interior space of the storage container; and
a bottom lid connected to the storage container by a hinge, wherein the lid is selectively opened for user access to the charging cable.

2. The system of claim 1, further comprising a cable stay that holds the charging cable in place when the bottom lid is lowered to an open position.

3. The system of claim 1, wherein the charging cable comprises a spiral configuration and further comprising an elastic component attached to the charging cable and biased to coil the charging cable into a shorter length for storage in the storage container.

4. The system of claim 1, further comprising an automated actuator connected to the storage container and the bottom lid, wherein the automated actuator is configured to open and/or close the bottom lid.

5. The system of claim 4, wherein either the automated actuator or a different motorized connection to the bottom lid are configured to open and/or close the bottom lid.

6. The system of claim 4, further comprising a lid cable connected to the bottom lid, wherein the lid cable maintains contact with the automated actuator to open or close the bottom lid.

7. The system of claim 6, wherein the lid cable and the actuator provide a designated ratio of lid movement distance relative to a length of the lid cable extending from the automated actuator.

8. The system of claim 1, further comprising:
a charging controller connecting the charging cable to a power source;
an electronic hardware configuration that implements data commands;
an automated actuator connected to the bottom lid and in data communication with the electronic hardware configuration.

9. The system of claim 8, further comprising a lid cable connecting the automated actuator to the bottom lid.

10. The system of claim 8, further comprising indicator lights connected to the electronic hardware configuration and indicating that the bottom lid is lowered, the bottom lid is raised, vehicle charging is ongoing, a vehicle is present on the ground surface below the storage container, the vehicle is fully charged, and other charging information.

11. The system of claim 1, further comprising a charging gun connected to the charging cable, wherein the charging gun is configured to connect to a charging port of a vehicle.

12. The system of claim 1, further comprising a holster connected to the storage container for securing the charging gun.

13. The system of claim 12, further comprising the holster connected to the bottom lid.

14. The system of claim 1, wherein the attachment mechanism comprises a hanging bracket that connects the system to a ceiling above the ground surface and provides for vertical adjustment in bracket length to raise or lower the height of the system.

15. The system of claim 14, wherein the attachment mechanism comprises an end connection configured to attach to a track connected to the ceiling and allows the system to manually slide across the ceiling structure in a horizontal direction.

16. The system of claim 15, wherein the attachment mechanism is automated to traverse the track via a motor controlled by a computer or the electronic hardware configuration.

17. The system of claim 15, further comprising a pivoting pull-push bar connected to the storage compartment to allow the user to manually slide the system in the horizontal direction across the ceiling structure from the ground surface.

18. The system of claim 1, further comprising:
a charging controller connecting the charging cable to a power source;
an electronic hardware configuration that implements data commands;
an automated actuator connected to the bottom lid and in data communication with the electronic hardware configuration, wherein operation data received by the electronic hardware configuration is used to control the automated actuator to lower and raise the bottom lid with a lid cable.

19. The system of claim 18, further comprising:
a wireless control switch transmitting the operation data in a wireless data transmission; and
wireless communications hardware in the electronic hardware configuration that processes the operation data received in a wireless protocol.

20. The system of claim 18, wherein the charging controller is attached to the bottom lid.

21. The system of claim 18, wherein the storage container further comprises at least one side wall to which the charging controller is attached.

22. The system of claim 18, wherein the automated actuator is a linear actuator connected to one of the at least one side walls.

23. A system for charging an electric vehicle, the system comprising:
a storage container defining an interior space between a bottom lid and side walls connecting the first surface and the bottom lid;
at least one attachment mechanism connected to the storage container and configured to mount the container in an elevated position relative to a ground surface;
a charging cable secured at least partially within the interior space of the storage container; and
an actuator positioned at least partially within the interior space of the storage container and configured to advance the charging cable generally in a direction across a long axis of the storage container, which correspondingly moves an end of the charging cable outside the storage container in a direction toward the ground surface.

24. The system of claim 23, wherein the storage container defines a payout aperture through which the charging cable extends.

25. The system of claim 23, wherein the actuator is a linear actuator, and the system further comprises a wheel connection around which the charging cable rotates as the linear actuator is extended and retracted.

26. The system of claim 23, further comprising a constant tensioning device comprising a retractor line connected to the charging cable, wherein the constant tensioning device pulls the charging cable with the retractor line to lower the charging cable out of a payout aperture in the storage container, and wherein the constant tensioning device is connected to the storage container.

27. The system of claim 26, wherein the charging cable extends from the retractor line with degrees of freedom selected from the group comprising forward, backward, left and right relative to the retractor line to access a vehicle's charging port.

27. The apparatus of claim 23, further comprising a charging controller connecting the charging cable to a power source.

28. The apparatus of claim 23, further comprising an electronic hardware configuration that implements data commands, wherein the electronic hardware configuration is in data communication with the actuator and wherein operation data received by the electronic hardware configuration is used to control the actuator to lower and raise the charging cable.

29. The apparatus of claim 23, further comprising a charging controller connecting the charging cable to a power source.

30. A system for charging an electric vehicle, the system comprising:
a storage container defining an interior space therein and generally positioned above a ground surface on which a vehicle can park;
a charging cable at least partially within the interior space of the storage container;
a bottom lid connected to the storage container by a hinge, wherein the lid is selectively opened for user access to the charging cable;
a charging cable retractor assembly within the storage container and connected to the charging cable, wherein the charging cable retractor assembly selectively allows the charging cable to extend away from the bottom lid for charging and retract into the storage container for storage.

31. The system of claim 30, further comprising a retractor line that is extendable and retractable from a charging cable retractor assembly and connected to the charging cable,
wherein the retractor line comprises an extended position to move the charging cable to a suspended position when the bottom lid opens, and
wherein the retractor line comprises a retracted position that holds the charging cable proximately to the bottom lid in a closed position.

32. An apparatus for storing a charging cable, the apparatus comprising:
a storage container defining an interior space within a plurality of side walls;
a bottom lid connected to one of the side walls;
a hinge connecting a first end of the bottom lid to the one of the side walls;
a charging cable that fits within the interior space of the storage container and connects to the bottom lid with a securing assembly that allows for the charging cable to be attached or detached from the bottom lid, wherein the charging cable is further connected to a power assembly;
a retractor line that is extendable and retractable from a charging cable retractor assembly secured within the storage container and connected to the charging cable,
wherein the retractor line comprises an extended position to move the charging cable and the bottom lid to a suspended position when the bottom lid opens, and
wherein the retractor line comprises a retracted position that holds the charging cable and the bottom lid in a closed position.

33. The apparatus of claim 32, wherein the power assembly comprises a charging controller connecting the charging cable to a power source with the power assembly.

34. The apparatus of claim 32, further comprising a retractor actuator assembly connected to the retractor line to extend and retract the retractor line from the charging cable retractor assembly.

35. The apparatus of claim 34, wherein the retractor actuator assembly connected to the retractor line comprises a motor and a retractor line wheel that extends and retracts the retractor line from the charging cable retractor assembly to open and close the bottom lid for access to the charging cable.

36. The apparatus of claim 34, further comprising an electronic hardware assembly that implements data commands, wherein the electronic hardware assembly is in data communication with the actuator assembly to open and close the bottom lid.

37. The apparatus of claim 36, further comprising:
a lid cable connected to the bottom lid and an automated lid actuator, wherein operation data received by electronic hardware assembly is used to control the automated lid actuator to lower and raise the bottom lid with the lid cable.

38. The apparatus of claim 36, further comprising:
an electronic hardware assembly that implements data commands and is in communication with the actuator assembly that extends and retracts the line.

39. The apparatus of claim 32, further comprising:
a rotating lever arm connected inside the storage container with a second hinge;
a tensioning device line connected to the rotating lever arm at a position separated from the second hinge;
a constant tensioning device secured within the storage container and connected to the tensioning device line, wherein the rotating lever arm supports a portion of the charging cable extending from the storage container.

40. The apparatus of claim 39, wherein the rotating lever arm comprises an extended position that partially supports the charging cable during operation of the bottom lid, and wherein a position of the rotating lever arm determines an angle at which the charging cable can be extended off of the bottom lid.

41. A system for charging an electric vehicle, the system comprising:
a storage container defining an interior space therein;
a bottom lid connected to the storage container by a hinge;
a charging cable that fits within the interior space of the storage container;
a charging controller connecting the charging cable to a power source;
an electronic hardware assembly that implements data commands;
an automated actuator connected to the storage container and in data communication with the electronic hardware assembly;
a lid cable connected to the bottom lid and another section of the storage container, wherein the lid cable maintains contact with the automated actuator, and
wherein operation data received by the computer is used to control the automated actuator to lower and raise the bottom lid with the lid cable.

42. The system of claim 41, further comprising a control switch transmitting the operation data to the electronic hardware configuration.

43. The system of claim 41, further comprising:
a wireless control switch transmitting the operation data in a wireless data transmission; and
wireless communications hardware connected to the electronic hardware configuration that processes the operation data received in a wireless protocol.

44. The system of claim 41, wherein the charging controller is attached to the bottom lid.

45. The system of claim 41, wherein the storage container further comprises at least one side wall to which the charging controller is attached.

46. The system of claim 41, further comprising:
a top section of the storage container positioned oppositely from the bottom lid and across the interior space; and
an attachment mechanism connected to the storage container and to a ceiling surface having a height dimension that provides clearance for the bottom lid to open at the hinge.

47. The system of claim 41, further comprising a power source connected to the charging controller and the charging cable.

48. The system of claim 41, further comprising a rotating lever arm connected inside the storage container with a second hinge, wherein the rotating lever arm supports a proximal portion of the charging cable, relative to the storage container, during operation of the bottom lid, and wherein a position of the rotating lever arm determines an angle at which the charging cable can be extended away from the bottom lid.
